(19) United States
(12) Patent Application Publication
(10) Pub. No.: US 2010/0146294 A1
(43) Pub. Date: Jun. 10, 2010

(54) BEST2000C: platform-independent, acrostic database encryption of biometrically-inert transgression-ciphers for up to 90% reduction of the $50 billion annual fictitious-identity transgressions

(76) Inventor: Anthony Sneed, Claremont, CA (US)

Correspondence Address: Anthony Sneed, 2058 N. Mills Avenue, Claremont, CA, 91711, US

(21) Appl. No.: 12/381,901

(22) Filed: Mar. 17, 2009

Related U.S. Application Data
(60) Provisional application No. 61/069,671, filed on Mar. 17, 2008.

(51) Int. Cl. G06F 12/14; H04L 9/00

(52) U.S. Cl. 713/189

(57) ABSTRACT

The invention (“INVENTION”) herein relates to government or private-use ciphers for assignable fictitious-identity information accessed through a data system or other form of data repository for maintenance or retention of financial, credit, medical or related asset management records. To help protect or restore integrity to such government or private-use ciphers occasionally compromised through private, public or commercial transactions, the art applies a prime/number-keyed acrostic-encryption throughout a data system or other form of information repository, encoding biometrically-inert transgression ciphers (“BIT-ciphers” or “TRANSGRESSION-CIPHERS”) therein. Such BIT-ciphers and their financial, credit or related asset management records form fictitious-identities, unassigned to any real person or real institution. These are populated throughout an extant data system or other form of information repository, including archival storage, containing preexisting fictitious-identity ciphers (“FID-ciphers”) assigned by a government or agencies, thereof, to online records for various parties, whether they be public or private institutions, corporations or individuals. FID-ciphers are processed through extant government and commercial systems for tax collections, credit monitoring, financial transactions and other forms of fictitious-identity processing. However, every BIT-cipher accessed through encoded government or commercial systems, or access of any BIT-cipher's related record components, in any way, triggers a 100% positive detection of a fictitious-identity transgression at the moment of access. A Fast-Access Network of Transgression Alert Servers for Transparently Implanted Ciphers version 7 (herein “FANTASTIC-7™”) allows instant capture and/or monitoring, for extended periods, of a party or parties engaged in fictitious-identity transgression.

### HISTORIC BACKGROUND OF INVENTION

### [IBM® is a trademark of International Business Machines Corporation, Armonk, N.Y.]

The present INVENTION relates to a general class of cipher applications, historically applied by governments, agencies thereof, or by a private-party or parties acting under the auspices of a government, or by combinations of governments, or by a non-governmental organization allowed to provide various services to communities of people within a nation, to an entire nation, or through multinational entities. The class of cipher application of interest in the present art is specific to accessing a data system or other form of information repository for reference, maintenance, research or retention of private or public credit, financial, medical or related asset files regulated or purposed by government or allowed agencies thereof. The present art benefits from, and is informed by a long history of nations', kingdoms' and empires' production, processing, and application of demographic ciphers. Such historical demographic cipher production, referenced herein, helped nations, kingdoms and empires perpetuate themselves and maintain their institutional forms and oversight functions, often in competition with other nations, kingdoms and empires either similarly informed or less informed about demographic ciphers and their benefits.

Demographic cipher production through census (Latin for “to tax”) has long been practiced by nations, kingdoms and empires, usually for revenue collection purposes, or for electoral representation assignment, or for military conscription, or for proportioning various resources. Such enumeration methodology represents one of the earliest, limited kinds of demographic cipher production a government or leadership might employ to perpetuate itself. Enumerations were either voluntary or compulsory, or not conducted at all, varying nation to nation across time as competitive and social circumstances might dictate.

Demographic cipher production is an outgrowth of know-how, computational methods and enabling technologies gradually evolved over centuries. A historically relevant precedent records an early enumeration of 603,550 men and resulting demographic ciphers in or about the 1200's B.C. And those demographic ciphers were initiated independent of any earthly authority, according to an ancient manuscript (herein “Transcript”):
“The [I-SHALL-BE] spoke to Moses in the Tent of Meeting in the Desert of Sinai on the first day of the second month of the second year the Israelites came out of Egypt. He said: “Take a census of the whole Israelite community by their clans and families, listing every man by name, one by one. You and Aaron are to number by their divisions all the men in Israel twenty years old or more who are able to serve in the army.” Numbers 1:2,3
All the Israelites twenty years old or more who were able to serve in Israel's army were counted according to their families. The total number was 603,550. Numbers 1:45, 46

Shared-resources and, later, land were apportioned based on this precedent-setting national census and its demographic ciphers defining specific individuals as within families, or “tribes,” collectively forming this new nation. According to a subsequent reference in Transcript documenting the above, not ALL demographic cipher production is to a nation's benefit, and the motive for production, in some instances, may actually be evil:
Satan rose up against Israel and incited David [king of Israel] to take a census of Israel. So David said to Joab and the commanders of the troops. “Go and count the Israelites from Beersheba to Dan. Then report back to me so that I may know how many there are.”
   1Chronicles 21:1,2
But Joab did not include [the tribe of] Levi and [the tribe of] Benjamin in the numbering, because the king's command was repulsive to him. This command was also evil in the sight of God; so he punished Israel. Then David said to God, “I have sinned greatly by doing this. Now, I beg you, take away the guilt of your servant. I have done a foolish thing.”
The [I-SHALL-BE] said to Gad, David's seer, “Go and tell David, ‘This is what the [I-SHALL-BE] says: I am giving you three options. Choose one of them for me to carry out against you.’”
So Gad went to David and said to him, “This is what the [I-SHALL-BE] says: ‘Take your choice: three years of famine, three months of being swept away before you enemies, with their swords overtaking you, or three days of plague in the land, with the angel of the [I-SHALL-BE] ravaging every part of Israel.’ Now then, decide how I should answer the one who sent me.’”
David said to Gad, “I am in deep distress. Let me fall into the hands of the [I-SHALL-BE], for his mercy is very great, but do not let fall into the hands of men.”
So the [I-SHALL-BE] sent a plague on Israel and seventy thousand men of Israel fell dead.
   1Chronicles 21:6-14

The wherewithal to produce and process demographic ciphers represents a unique application of governmental authority, in parallel with tax collection, judicial oversight, law enforcement and military preparedness. Enumeration ciphers determine governmental organization, revenue sources, constituent representation, manpower availability, agricultural and food production, economic allocations and social planning in conjunction with various data collection metrics. Producing and processing demographic ciphers is technically perceived as one of the most benign exercises of a governmental authority. Yet, demographic ciphers and their use evidence values and intentions of a nation, its leadership and its institutions. This may either be to the detriment or benefit of constituencies encompassed, as well as perpetuation or destruction of a cipher-aware government. Such cipher awareness and use of enumeration ciphers, once established, may forever be part of the historical record reflecting the character of a governing entity exercising this unique form of franchising power. The historical record shows that the more a government can know through its demographic cipher production, the more it wants to know, limited only by technology, wherewithal and methods. Such desire may reflect a recurring theme in the history of nations, especially when informed exclusively by the pursuit of security and wealth concentration.

At or about 12 centuries after the precedent of the 603,550-man census noted above, Rome conducted compulsory enumerations of some 60 million people, its entire population, producing demographic ciphers accurate to within ±16%. It was the largest multinational census in the world up to that time, occurring about 1,995 years ago. Nothing on such a scale encompassing so much of the earth's land area had ever been attempted in the history of mankind since the flood of antiquity. These two enumeration precedents—the Roman enumeration in or about the 1^{st} century A.D. and the earlier-mentioned 603,550 man census in or about the 12^{th} century B.C.—intersect in one family and one child thereof, captured in Transcript:
In those days Caesar Augustus issued a decree that a census should be taken of the entire Roman world. (This was the first census that took place while Quirinius was governor of Syria.) And everyone went to his own town to register. So Joseph also went up from the town of Nazareth in Galilee to Judea, to Bethlehem the town of David, because he belonged to the house and line of David. He went there to register with Mary, who was pledged to be married to him and was expecting a child.

Luke the physician's letter to his patron Theophilus in the 1^{st} century A.D. Luke 2:1-5

Transcript indicates demographic cipher processing was applied while physically sorting the nation's population in an attempt to identify this particular child, deemed a national security risk. Based on Transcript, demographic processing, along with genealogical research at the highest levels of government, could only identify the approximate age of the child, his gender, and presumed paternal ancestry. These metrics were specific enough to locate the child's vicinity and whereabouts within the vast Roman empire, encompassing some 60 million living souls at the time. Once the child's town was identified, every male two (2) years and under was executed to remedy the perceived national security risk. The efforts and wherewithal of the most powerful government of that time were an utter failure in this regard, as a later official acting on behalf of the Roman government discovered when confronting that child after the child became a grown man. According to Transcript, that Roman official addressed the long-standing accusation that the child's birth represented a national security risk to Rome:
“You are a king, then!” said [the regional Roman governor].
[The grown child] answered, “You are right in saying I am a king. In fact, for this reason I was born, and for this I came into the world, to testify to the truth. Everyone on the side of truth listens to me.” John 18:37

The hearing by the regional Roman governor attempted to resolve the identity of the party being questioned in light of allegation brought against that party. The evidence presented, though contradictory during the proceedings, left the matter of the party's identity open. The allegation by various officials was that the party was acting under a fictitious-identity which threatened the stability of the state and the Roman empire. All testimony against the party proved contradictory, and the party did not perform any supernatural act or anything else out of the ordinary during proceedings conducted by the Roman governor or other officials. Nor was evidence presented suggesting such abilities.

The only consistent evidence presented the Roman governor was that the party was an ordinary man, or if a “king” was one without earthly jurisdiction or realm based on the party's own admission, “Everyone on the side of truth listens to me.” No witness was presented nor did any come forward who claimed to have “believed” the party. Nor did anyone in the Roman government or other officials in any capacity whatsoever make such allegation. As to the party's referencing the term “truth” in his answer, the Roman governor found no cause of action, and presumed the party's context rhetorical or philosophical rather than probative. Ending the hearing, the Roman governor rhetorically asked, “What is truth?”, concluding that reference to “truth” in a rhetorical or philosophical context was not a cause of action by the state.

The demographic ciphers produced from that earlier Roman census, which included the child noted, informed its emperor and government about the strengths and weaknesses of multinational constituencies within the empire, as well as their military, political and revenue potential. Nothing would approach this Roman census precedent in sheer magnitude and breath until over 1,785 years later, long after Rome faded as a world empire. In 1789, a new government took form and began to rise up on earth, becoming the United States of America, after freeing itself from England's king—ancient England itself having formerly been subject to Roman dominion and census. America would eventually take the idea of demographic cipher processing into realms which Roman leadership might only have dreamt.

Under heaven, the United States was permitted to establish a new Constitution in the Western Hemisphere of the world, informed by a republican, bicameral from of government in the image of Rome's. That Constitution was ratified in 1788. It included authority for the newly-formed U.S. congress to produce useful demographic ciphers through a decennial census. Like Roman law, the U.S. Constitution also considered interests of property owners and tenants, as well as identifying parties within state-recognized marriages and offspring thereof assigned fictitious-identities as “whole persons” (“Whole-Persons”); and parties in marriages excluded state recognition and offspring thereof assigned fictitious-identities as “all other persons.” Those marriages excluded from state recognition, by law, could be dissolved and parties with fictitious-identities thereof casually separated by third-party property and economic interests. The Constitution defined cipher-specific enumeration methods for determining fictitious-identities, whether for Whole-Persons or “all other persons”:
Representations and direct taxes shall be apportioned among the several states which may be included within this Union, according to their respective numbers, which shall be determined by adding to the whole number of free persons, including those bound to service for a term of years, and excluding Indians not taxed, three-fifths of all other persons. The actual enumeration shall be made within three years after the first meeting of the Congress of the United States, and within every subsequent 10 years, in such manner as they shall by law direct.
   U.S. Constitution, Article 1, Section 2, Clause 3, as of 1790

This, too, may have harmonized with Roman demographic cipher production methods. Yet, regarding the union of any husband and wife permitted under heaven, and offspring thereof—before earthly governments existed—it remained written within Transcript regarding marriage:
So they are no longer two, but one. Therefore what God has joined together, let man not separate.
   Genesis 2:24, Matthew 19:6

In Article IV, Section 2, Clause 3 of the Constitution, “all other persons” is further uniquely prescribed within the expression “persons held to service.” The clause implicitly includes two classes of fictitious-identities of “persons held to service.” One class are those persons held to LIMITED terms of “indentured service” by agreement or for cause. The other class, specific to “all other persons” in Article 1, Section 2, Clause 3, are persons held to service by fictitious-identity dicta for indefinite periods or for life (herein “Person Held by fictitious-identity Dicta” or “PHD”). Certain states allowed communities of men and women, acting under fictitious-identities as Whole-Persons (“Claimant”), to issue local dicta and claim an individual a PHD to be legally held by a private-party.

In so doing, by local dicta alone, even if by only a single Claimant, such claim became enforceable within said states and common law thereof. Once done, a designated individual could not be claimed a PHD by any other party without compensation to the Claimant. Under Article IV, once an individual, by local dicta, became held to such a fictitious-identity as a PHD, that individual was without protection or legal recourse whatsoever against certain coercive and categorical forms of abuse; including adultery, murder, homo/heterosexual-rape, pedophilia and sexual or other forms of exploitation for monetary gain.

Through Article IV, categorical forms of abuse, including adultery, murder, homo/heterosexual-rape, pedophilia and sexual or other forms of exploitation for monetary gain, were made legal under the Constitution within certain states, through legalized creation of fictitious-identities. In actual practice, a Claimant, under fictitious-identity as a Whole-Person and an agent within certain states, could molest the peaceful union of a husband, wife, offspring and subordinate all thereof to a Claimant's private propensities and purposes, including the most depraved, for indefinite periods, or for life, under Article IV, Section 2, Clause 3.

A Claimant, specifically those acting under fictitious-identity as a Whole-Person with allowed pathological propensities under Article IV, could legally molest the peaceful union between a husband, wife, offspring and all thereof. This was construed as a categorical form of “service” under color of authority, sanctioned as a special entitlement for any Claimant acting under fictitious-identity as a Whole-Person within certain states. And PHDs so molested would by law be in violation of Article IV if attempting to flee such forms of abuse:
No person held [by fictitious-identity dicta or] to service or labor in one state, under the laws thereof, escaping into another, shall, in the consequence of any law or regulations therein, be discharged from such service or labor, but shall be delivered up on claim of the party [Claimant] to whom such service or labor may be due.
   Article IV, Section 2, Clause 3

An egregious defect of such provision—besides encompassing and legalizing murder, adultery, homo/heterosexual rape, pedophilia and sexual or other forms of exploitation for monetary gain under positive law—was the right it gave a Claimant acting under fictitious-identity as a Whole-Person to void any contract or agreement made with a PHD at any time. Since a PHD had no standing before any court, there could be no tort if any form of agreement were broken. An example might be a Whole-Person's oral anticipatory-breach agreement (“Anticipatory-Breach”) with a PHD that. “If you double my crops over the next four years, I will discharge you and your family from any further obligation of service to me.” Such Anticipatory-Breaches were regularly exploited to maximize production and performance far beyond what coercion, physical abuse and even threat of murder or bodily harm might accomplish. Later, the Anticipatory-Breach might be casually demurred or simply ignored altogether by reasserting a PHD's indefinite or life-long servitude under Article IV, by common dicta, and lack of standing before any court.

Afterward, the affected PHD's indefinite or life-long service enforced under Article IV and state laws derived thereof would remain unchanged. There was no obligation whatsoever to keep any Anticipatory-Breach with any PHD. And such Anticipatory-Breaches could be repeatedly made and broken with impunity while exploiting expectation created. A Claimant acting under a Whole-Person's fictitious-identity could breach agreement under a positive law entitlement codified through the Constitution. However, Anticipatory-Breach methods under the Constitution may have been, and were in conflict with the Laws of Nature referenced as foundational to the Constitution's origins:
When in the Course of human events, it becomes necessary for one people to dissolve the political bonds which have connected them with another, and to assume among the powers of the earth, the separate and equal station to which the Laws of Nature and of Nature's God entitle them, a decent respect to the opinions of mankind requires that they should declare the causes which impel them to the separation.
   Declaration of Independence, d5/Jul. 4, 1776

In other words, the government of England claimed the “divine right” to assign the fictitious-identities of “subject” and “colonist” by common law dicta. By 1776, parties living in America preferred neither fictitious-identity nor the proscribed obligations assigned such fictitious-identities under an alleged “divine right.” Resisting these fictitious-identities opened opportunity to have no fictitious-identities or a way to create new ones. That is, individual rights might become more real without a predestined “divine right” attached to the fictitious-identity of “monarch,” “subjects,” and “colonists.”

The framers of the Constitution (“Framers”) were aware of conflicts between the common good and using the power of the state to predestine fictitious-identities of any kind, as some agitated the Framers to consider. Morally repugnant offenses against the Laws of Nature—including but not limited to adultery, murder, homo/heterosexual-rape, pedophilia, sexual and other forms of exploitation for monetary gain and Anticipatory-Breach methods thereof—would be implicitly legalized throughout the new nation if a special-interest entitlement, based on fictitious-identities by private-party dicta, were embedded in the Constitution. Furthermore, the Framers anticipated future injury to a free market economy if a billion man-hour entitlement of uncompensated labor (herein “Billion Man-hour Entitlement” or “Entitlement”), based on legally enforced fictitious-identities, became nationalized. The Entitlement would also require a national ID system using demographic ciphers or other mechanism in the form of documentation, markings or biometrics, to protect the rights of those claiming the Entitlement as a special-interest group.

John Adams, one of the Framers who later became the second president of the United States, vehemently opposed including the Entitlement in the Constitution under any circumstances, along with nationalizing a fictitious-identity system based on private-party dicta, whether through documentation, markings or biogenetics. Such a dicta-based ID system could legalize, through positive law, intractable social pathologies, in direct conflict with the Laws of Nature and Nature's God. Such Nature references were foundational to the Declaration of Independence's themes and ideals which Adams helped author. Adultery, murder, homo/heterosexual-rape, pedophilia, and sexual or other forms of exploitation for monetary gain, along with Anticipatory-Breach methods, were, and would never be wholesome reflections of the Laws of Nature and Nature's God. Thomas Jefferson's inclusion of the terms Laws of Nature and Nature's God within the Declaration of Independence was informed by Enlightenment thinkers, ranging

Voltaire, as well as the English philosopher John Locke. Yet their Enlightenment thinking internalized flaws, especially “neopagan” anti-Semitism and “divine” genetic selection through embryo-predestination (“DGSTEP”). These “Enlightenment” precepts would sustain a worldwide system of coerced uncompensated labor in the 18^{th} and 19^{th} centuries, and through further perverse evolution in the 20^{th} century lead to the most destructive application of demographic ciphers for ethnic cleansing and genocide the world has witnessed.

To Jefferson, Nature's God, developed from an Enlightenment perspective, by necessity was not the one of European theocratic traditions or related deistical notions. Nor might such entity support any English king's “divine right” to abuse “colonists” in various ways without cause, especially to the detriment of inherent rights transcending all earthly governments. The colonists in fact had no cause of action or grounds for redress strictly under positive law, foundational to English common law, informed by the universally accepted “divine right of kings” throughout Europe. Thus, Jefferson could not establish argument in the Declaration of Independence based on extant coercive theocratic opinions, or any deity thereof, and certainly not positive law precedent under English common law.

Rather, Jefferson relied on Nature's God and the idea of a hands-off “watchmaker,” reflected within the Laws of Nature and their orderly operation throughout the earth and the universe, understandable by deduction, reasoning and observation. Jefferson attempted to base his “faith” on scientific methods informed by Galileo, Newton, Francis Bacon, and other scientists. Such scientists and other Enlightenment philosophers relied less, if at all, on uninformed opinion, “monkish ignorance” or superstition that might distort objective findings, or so Jefferson felt. Furthermore, other “colonists” perspectives about liberty were also, to a large degree, informed more by nature's verdant beauty and abundant variations of plant and animal life, on a scale urban European “subjects” couldn't easily experience through their everyday surroundings. Jefferson appealed to the human soul's transcendent yearning for harmony and the renewing inspiration of deductive beauty reflected in the physical orderliness of nature itself. In doing so, he rejected faith in myth, opinion or predestined fictional-identities of men or gods detrimental to ideals of liberty and natural gifts endowed by Providence. [reference: Alan Dershowitz, America Declares Independence]

And those gifts, Jefferson reasoned, were better nurtured through the fundamental right of inquiry respecting freedom of conscience to observe, investigate, discover and apply precepts, principles, and protocols to advance productive PERSONAL pursuits. By doing so, personal well-being and happiness would proportionally expand to enable shared-prosperity within mutually supportive and economically-secure communities, peoples, and nations for all mankind. He felt peoples, politics, property and profitable personal pursuits could be constructively harmonized and regulated within self-limiting forms of government. Furthermore, he believed government could and should be organized to serve democratically determined objectives. And those objectives he desired be anchored in Enlightenment ideals encompassing liberty, education, reasoning, and informed perspective beyond a consuming mammon of self-destructive propensities.

Jefferson chose not to base his beliefs exclusively on ancient texts or Transcript. Rather, he applied these in conjunction with many sources and points of view. His was an unshakeable faith in what could be achieved through direct observation and purposed reasoning from evidence independently verifiable by two or more reliable parties. And being so influenced, he attempted to make the Declaration of Independence free of sectarian bias or similar defect. In doing so, he took direct aim at religious traditions used by British royalty, or any royalty, justifying a “divine right” to unilaterally dictate decrees through a “supernatural” fictitious-identity, without the consent of the affected parties or representative bodies formed thereof.

The Billion Man-hour Entitlement and its fictitious-identities through embryo-predestination and private-party dicta, if formalized through written law rather than informally practiced by precedent, therefore were at odds with the Declaration of Independence's Nature's God and the Laws of Nature. Yet, the Constitution would have to reconcile aspirations intrinsic to the Entitlement's extant operation, at the time, and special interests' demands to formalize the Entitlement. If less than perfectly resolved, a persistent struggle would be set in motion at the very commencement of the Constitution's existence. And if prohibited, the Entitlement might itself violently spin-off into some new, separate nation or nations, contending for resources and space on the very continent the Constitution was attempting to gain a foothold upon earth.

The risk of not including the Entitlement, somehow, could lead to dissolution of the coalition of 13 states (herein “Coalition”) that legally separated themselves from Britain in 1783 at the conclusion of the War of Independence.

After the war, the Spanish, as of 1787, occupied the Florida peninsula (which translates to the English word “Easter”); the French maintained a territorial presence from the Gulf of Mexico up through the entire middle of the continent; and the British possessed sizeable territories toward the west and in Canada. All these European powers and their military proximity to the Coalition encouraged the Framers to find a way to adhere to ideals espoused in the Declaration of Independence while accommodating the Billion Man-hour Entitlement—a task of Sisyphean contradiction. The objective was to maintain the Coalition's union and shared-security, if at all possible. However, accommodating the Billion Man-hour Entitlement, and showing favoritism to sectarian or special-interest demands for perpetuating the Entitlement and its fictitious-identities by private-party dicta, placed the Framers in a quandary regarding extant, mutually supporting precepts within the Declaration of Independence and Transcript:
“[A]ll men are created equal [WITHOUT predestined fictitious-identities at conception].”
   The Declaration of Independence, d5/Jul. 4, 1776
But if you show FAVORITISM, you sin and are convicted by the law as LAWBREAKERS . . . . For he who said, “DO NOT commit adultery” [Exodus 20:14; Deuteronomy 5:18], also said, “DO NOT murder” [Exodus 20:13; Deuteronomy 5:17] . . . . If you DO NOT commit adultery but DO commit MURDER, you have become a LAWBREAKER.
   James 2:9-11

Furthermore, legalizing the Entitlement and fictitious-identities thereof under positive law might distort demographic cipher production for purpose of determining congressional representation and discerning meaningful governing metrics. And it would implicitly promote a national, fictitious-identity system defined by private-party dicta rather than Enlightenment-informed governing principles. Yet, not to accommodate the Entitlement under the Constitution could lead to dissolution or fragmenting the Coalition's pre-existing, shared-security arrangements within a contiguous region encompassing 13 new states under one, general, though limited form of government. And if the Coalition dissolved over the Entitlement's favoritism to Claimants' aspirations to assert fictitious-identities, the Constitution's ideals of equality might never reach millions of people cutoff and trapped, perhaps forever, in a separate nation or nations which might attempt to codify Entitlement and fictitious-identities thereof into perpetuity.

In addition, the non-dicta Coalition states, who fought to help win a precious liberty, would have to compete against the dicta-based states' Billion Man-hour Entitlement's production wherewithal, if a separate nation or nations were formed by the dicta-based states. Those resources might become formidable and external to the Constitution's ability to organize or influence them directly. Though morally defective in many ways, a potential Billion Man-hour Entitlement might give any country exceptional monetary and military advantages among agrarian-based nations of the time. At the core of any nation's prosperity was, and is, labor-intensive food production through crops like wheat, sugar, rice, beets, corn, other vegetables and fruits, as well as meats from animal husbandry and slaughter, and commercial harvest of crops like tobacco and especially cotton, dependent on low-cost production essential to expand and compete through international textile markets. The problem was how could a Billion Man-hour Entitlement be brought within the Constitution's framework without tainting ideals expressed in the Declaration of Independence? How could the Entitlement be included without extending it's fictitious-identity dicta and “divine” embryo-predestination into perpetuity?

The remedy the Framers attempted, led by John Adams, with encouragement for compromise from Benjamin Franklin and James Madison, among others, limited the Billion Man-, hour Entitlement to a specific region circumscribed within a subset of Coalition states. The circumscribed region would contain special-interests and those parties at odds with the Declaration of Independence, and who were agitating to perpetuate the Entitlement, its “divine” embryo-predestination and its fictitious-identity by dicta indefinitely. This would allow free-market forces to predominate in states outside the circumscribed Entitlement region. The Constitution would never define criteria about whom might, be construed a Whole-Person or whom might be construed a PHD, if anyone were so construed, any more than it would define fictitious-identities about whom might be a professor or whom might be an artist or engineer. All such fictitious-identity prerogatives, if any, would be among private-parties subject to state sovereignty and jurisdiction where the parties reside.

A homogenous population without reasonably consistent biogenetic differences to classify persons by distinctive physical characteristic could make enforcing the Entitlement under Article IV elusive. For example indentured servants NOT held to indefinite or life-long terms of servitude, could disregard their terms of service if opportunity arose or they were so moved to simply flee to other locales. Benjamin Franklin, himself, ran away from an “apprenticeship” obligation in Boston, and that fictitious-identity, to seek his fortunes in Philadelphia, and prospered magnificently by doing so. He went on to become the most successful fictitious-identity fugitives of his day, which benefitted the entire nation. Without a centrally coordinated fictitious-identity system or legally recognized biometric-identifier, voluntary compliance was the primary means by which fictitious-identities and limited terms of service, for seven years or less, were fulfilled. However, there were many successful fictitious-identity fugitives, like Benjamin Franklin, who were militantly indifferent to being “held to service” by dicta or fictitious-identity. The fact there was no national ID system, to uniquely mark Benjamin Franklin and other fictitious-identity-fugitives, or use genetic characteristics, or simply require him and others to carry identity papers, made fictitious-identity enforcement more voluntary than compulsory.

After the Constitution's ratification in 1789 and commencing with the first census in 1790, there was no extant precedent at the federal level for a national, fictitious-identity tracking system of any kind. It was enough just to attempt a count of the population of under 4 million souls by their state-assigned fictitious-identities. Notions of liberty had taken root, free of fictitious-identities as “colonists” or “subjects,” with guarantees under the Constitution as extensions of the Laws of Nature and Nature's God cited in the Declaration of Independence. This made any type of compulsory national fictitious-identity tracking system anathema. The formerly-endured Stamp Act of 1765 by the British (a tax on virtually any commercial item requiring printing or publication), the Townsend Act of 1767 (a tax on imported goods), and the Tea Act of 1773 (a tax to compel acceptance of British royalty's “divine right” to tax “colonists” by dicta) segregated the “colonists” from other British “subjects.” The taxes, themselves, represented a benign fictitious-identity cipher upon all “colonists,” infusing them with a shared-identity as a separate people from other English “subjects” or English speaking peoples.

Since “colonists” and British “subjects” had common genetic and physical traits, from outward appearance there was no meaningful biogenetic way to tell them apart for tax purposes, except, perhaps, by lexical usage and accent. Therefore, a person's residential locality acted to define his or her fictitious-identity as “colonist” or “subject” within the British Empire. And everyone with a residential locality in the American colonies was so identified and taxed accordingly. If a person moved to Britain or elsewhere outside the American colonies, it ended his or her residential-based fictitious-identity as a “colonist” and the tax would cease on that person. Thus, the tax was attached to a fictitious-identity based on residential locality as a geographic cipher, rather than a biogenetic attribute. The cipher wasn't intrinsic in any way to the individual himself or herself. In fact, if someone moved to the British colonies from elsewhere in the empire, he or she, too, would be subject to the same tax as any other American “colonist.” In this regard, the fictitious-identity cipher was benign or temporal, and not intrinsically attached to some unalterable personal attribute.

Conducting the 1790 census under the then-new Constitution, within provision of Article 1, Section 2, Clause 3, allowed, but did not require, assigning fictitious-identities for Whole-Persons and “all other persons” held to indefinite or life-long servitude, the latter as PHDs under Article IV. Yet allowing differentiation by private-party fictitious-identity dicta, under Article IV, was a concession to maintain the Coalition of states. Unlike the special British tax acts visited upon “colonists,” which relied on a geographic fictitious-identity cipher to determine taxability, Article I, Section 2, Clause 3 gave no hint as to who was whom relative to Whole-Persons and PHDs for 1790 census purposes, nor did it require any state to do so.

The Framer's provided no means to compel states to classify their residents based on fictitious-identities, or if they should legally classify and differentiate their populations in any way whatsoever for census purposes. It only provided provisions under Article I, Section 2, Clause 3 for a state to do so within its jurisdiction if its governor and legislature wished to do so. This gave each state freedom and sovereignty to assign fictitious-identities to all residents as Whole-Persons and none as PHDs; or some residents as Whole-Persons and others as PHDs; or all residents as PHDs and none as Whole-Persons. Furthermore, for social engineering purposes, the criteria could be biometric, genetic, genealogic, economic or any other classification a particular state might choose within its jurisdiction. As such, fictitious-identity franchises could exist within states and be perpetuated by private-parties under a state's jurisdiction, establishing markets for PHDs based on supply and demand, without interference from the federal government. Such markets might be perpetuated, by law, in conjunction with any other market for goods and services.

Article I and Article IV insulated the federal government from the particulars of whatever fictitious-identity system states might apply to segment residents into Whole-Persons or PHDS. Each state had the discretion to engage or not engage this provision allowed under the Constitution. To quote a 21^{st} century Supreme Court Justice's per curiam opinion in Pacific Mutual Life Insurance Company v. Haslip, relative to internal practices that might differ state to state, informing how states might structure their electoral franchises:
Nonuniformity can not be equated with constitutional infirmity.

In other words, it was possible to “have it both ways” within states' rights provisions. Presumed sovereignty each state enjoyed under the Constitution in 1790 allowed differing applications of Article I, Section 2, Clause 3, state by state, to establish fictitious-identity systems, jurisdiction by jurisdiction. That is, a state with 200,000 people, for representation purposes, could define its population as anywhere from 120,000 if all parities therein were construed as PHDs, and up to 200,000 if all parties therein were construed a s Whole-Persons—or any number in between. And assigning fictitious-identities to PHDs and Whole-Persons was not prescribed nor limited by the Constitution, but left to the states. The criteria used could be height, hair-color, eye-color, accent, head shape, ancestry, or any other biogenetic trait. Or it could be based on one's intrastate locality, or one's heath condition, social affiliation or whatever a state might choose. There was simply no expressed restriction under positive law or “original intent” within the Constitution. And that ambiguity, regarding future, national, fictitious-identity ciphers, set a probative precedent.

Fictitious-identity social engineering was historically practiced, under color of authority, within the Western Hemisphere and other regions' of the world prior to the Constitution's ratification. The most enduring practices relied on a biogenetic attribute reasonably constant generation to generation. Hair color, height, eye color, accent and head shape, among other traits, were subject to change, even within the life-time of an individual, and might be difficult to readily discern from a distance. Furthermore, none of these traits was reliably transgenerational, or consistently passed on to off-spring who in turn consistently passed the trait on to their off-spring. The son or daughter of a tall, blond, blue-eyed person might be other-than tall, blond and blue-eyed.

The final solution adopted in pre-Constitution America was biogenetically-based involving transgenerational traits. The Solute-Carrier-Family-24-Member-5 gene and genetic complex thereof (herein “slc24a5-cipher”) helps determine melanosome production from melanoite cells within the human epidural layer. The 111^{th} amino acid in the slc24a5-cipher contains a protein sequence involving the presence of, among others, one of two genetic markers: alanine, occurring 93% to 100% of the time for people of African and East Asian descent; and theonine which occurs 98.7% to 100% of the time for people of European descent. If alanine and theonine are considered two, discrete binary-values of the slc24a5-ciphers, their presence, or absence, is readily detected from outward appearance of an individual in the U.S., prior to mass migration or obviating miscegenation laws in the 20^{th} century. The last such legacy-ruling by the Supreme Court, specific to marriage and matching the slc24a5-cipher's discrete binary-values between parties, was in or about 1967.

The 1790 federal enumeration, under Article I, Section 2, Clause 3, was performed with care not to interfere in any way with pre-existing use of the slc24a5-cipher on a state by state basis. In practice, states were allowed to use the slc24a5-cipher to establish fictitious-identities and compute congressional representation using agreed on binary values. Mathematically speaking, based on information theory, the slc24a5-cipher was used to quantify a binary system consisting of two, and only two, symbolic values: Fictitious Identity Dicta:000-00-0000 (“FID:000-00-0000” or “FID:0”) for persons having theonine in the 111^{th} amino acid of their slc24a5-cipher; and Fictitious Identity Dicta:000-00-0001 (herein “FID:000-00-0001” or “FID:1”) for persons having alanine in their 111^{th} amino acid of their slc24a5-cipher. The states determined how the FID:0 and FID:1 ciphers would be applied within their jurisdictions during a federal census. For enumeration purposes, BOTH FID:0 and FID:1 are symbolic, dicta-based identity ciphers, assigned at the discretion of state governments, yet used by the federal government in decennial enumerations.

A widely-held belief, construed from a defective reading of Transcript, was that the slc24a5-cipher was “divinely” introduced within humanity to physically identify the descendants of a man named Canaan, who was the son of his father Ham, who was the son of a patriarch named Noah. The Transcript discloses that Noah built an ark to save his family and animal life from a worldwide flood (“Flood”). According to Transcript, after the Flood, Noah planted a vineyard, made wine, drank it, became drunk and passed out, as perhaps a post-traumatic response to surviving a worldwide catastrophe. Subsequent to this, it is written:
When Noah awoke from his wine and found out what his youngest son had done to him, he said,
“Cursed be Canaan! The lowest of slaves will he be to his brothers.”
   Genesis 9:24,25

The belief held by special-interests within some states, at the time of the 1790 census, was that the slc24a5-cipher was “divinely” assigned to identify parties predestined to indefinite or life-long servitude, or that all such parties were descendants of Canaan, the first-person subjugated to life-long servitude after the Flood of antiquity, recorded in Transcript. Therefore, certain parties within some states cited this single verse to construe any descendant of Canaan, whether found in America or brought to America, as “divinely” subjugated and by dicta could be assigned a “predestined” fictitious-identity and held under Article IV for indefinite or life-long servitude.

Excluded were parties with Canaan's slc24a5-cipher—whatever that cipher might be—yet who didn't appear to have Canaan's physicals traits—whatever those traits might be. Whole-Persons' and PHDs' fictitious-identities, therefore, were issued forth by private-party dicta, based on sectarian or religious opinions, under color of authority from Article IV. Thus, it became real through positive law that every Claimant acting under fictitious-identity as a Whole-Person had the “right” to legally engage in adultery, murder, homo/heterosexual-rape, pedophilia, and sexual or other forms of exploitation for monetary gain, if so moved. And a Claimant's fictitious-identity dicta, to “hold” a PHD, indirectly bound everyone living in the U.S., such that no one else could claim the same PHD or provide aid in any way under heaven to her.

Furthermore, it was presumed by special-interests in some states that Canaan had the slc24a5-cipher with alanine in its 111^{th} amino acid position, discernable from Canaan's physical appearance—whatever that physical appearance might be, which is not explicitly disclosed in Transcript. Additionally, some states concluded that anyone with similar physical appearance to Canaan in or about 1790—whatever that physical appearance might be—could be construed a descendant of Canaan and therefore predestined for indefinite or life-long servitude. And the first Claimant on earth who met such an individual could hold that individual “to service” by common fictitious-identity dicta under Article IV, enforceable by a state's governor, legislature and laws thereof.

This “divine” finding, when applied during the 1790 census, construed any embryo having Canaan's slc24a5-cipher, in a FID:1 state, by law, as predestined for indefinite or life-long servitude after birth. Though the slc24a5-cipher's 111^{th} amino acid could only be determined after birth in 1790, the Constitution empowered FID:1 states through laws thereof, to reach back to an embryo's inception. That is, at the instant an embryo's DNA became “separate and distinct” under heaven, that embryo could be legally construed, within a FID:1 state, as a Whole-Person or a PHD predestined to indefinite or life-long servitude, based on the slc14a5-cipher's 111^{th} amino acid. “Divine” precedent was presumed to determine an embryo's DNA at conception for use by a FID:1 state to issue a fictitious-identity, whether as a Whole-Person or PHD. If after birth a newborn had any reasonably similar physical characteristics to Canaan—whatever Canaan's physical appearance might have been, or however it was construed by “divine” precedent—such an embryo became subject to fictitious-identity dicta under Article IV, and was construed and held as a PHD. Otherwise the newborn was construed a Whole-Person. There was no exception for every child born in a FID:1 state.

The prenatal technology from 1790 to 1865, and prior, was primitive to say the least. The slc24a5-cipher's 111^{th} amino acid's binary value, upon which FID:1 state laws relied, was only discernable on earth, to any degree, after birth, even though the law reached back to an embryo's “divine” conception. Therefore, in any FID:1 state, every embryo's “predestined” status for indefinite or life-long servitude was suspect, based on the slc24a5-cipher, until after birth. As with 20^{th} century quantum mechanics, the “predestined” fictitious-identity of every embryo, from 1790 to 1865, could not be legally “construed,” pending the slc24a5-cipher's binary value determined after birth.

Human passion, through billions of temporal unions, coercive or otherwise, between 1790 and 1865, could be completely indifferent to slc24a5-cipher distinctions nuanced by law or “divine” precedent. And a Claimant acting under fictitious-identity as a Whole-Person could completely disregard a PHD's declaration of monogamy in a FID:1 state, through passion or other personal predilection, independent of a PHD's gender. Under positive law through Article IV of the Constitution, a Claimant acting under the fictitious-identity as a Whole-Person could disregard any consequence of conception with a female PHD and legally terminate the life of any born or unborn child so conceived under Article IV.

That is to say prior to 1865, a Claimant acting under fictitious-identity as a Whole-Person could legally abort or terminate a PHD's unborn or born child, or compel a PHD to do the same under the Constitution. The legality of such abortion was fully and completely encompassed by the 1857 Supreme Court's 7-2 decision in Scott vs. Sanford/Sandford, construed under fictitious-identity as “The Dred Scott Case.” Due to an administrative irregularity, the Court assigned Mr. John F. A. Sanford the fictitious-identity John F. A. Sandford. Thus Sanford/Sandford is a fictitious-identity precedent for a Claimant acting as a Whole-Person before the Court, precedent thereof encompassing a private-party abortion “right” under stare decisis.

For Scott vs. Sanford/Sandford, such a private-party abortion “right” ended with the 13^{th} Amendment in 1865, and no new private-party abortion “right” was reestablished by the Supreme Court until the 5-4 decision in Roe vs. Wade of 1973. With the 1973 ruling, the law again reached back to conception of any embryo, not only birth, and the power retained within the Constitution, under heaven, to legally predestine the life or death of any embryo by private-party dicta, was reaffirmed.

Prior to 1865, Article IV was specific only to PHD embryos and their “divine” predestination for indefinite or life-long servitude. The Civil War from 1861 to 1865 ended such “divine” practices and stare decisis by which the Supreme Court sustained them. After the 1973 Roe vs. Wade ruling, all embryos, independent of ancestral fictitious-identity affiliation, became subject to the Supreme Court's 1857 precedent in Scott vs. Sanford/Sandford allowing abortion by private-party dicta. In the late 20^{th} century for instances where a surplus of viable embryos were produced through artificial insemination, such “orphan” embryos could become subject to indefinite or life-long servitude to the state for medical research or other uses, including being sold or killed for experimentation. And this, too, was by private-party dicta of a single individual.

Furthermore, Scott vs. Sanford/Sandford respected and protected the “right” of a Claimant, acting under fictitious-identity as a Whole-Person, to legally engage in homo/heterosexual-rape or pedophilia with a PHD, since a PHD had no standing before any U.S. court. And a PHD attempting to flee such a Claimant,' under Article VI, could be executed without question for resisting arrest or recapture by a U.S. Marshall for return to a Claimant. As of 1850 and federal law thereof (herein “1850 Fictitious-Identity Rendition Act”), any Whole-Person in any state, attempting to assist any PHD escaping such a Claimant, would be subject to fine and/or imprisonment. In other words, all Whole-Persons were legally bound by the so-called 1850 Fictitious-Identity Rendition Act, to actively assist in the capture and return of a PHD to such a Claimant. To do otherwise would not only be considered “unpatriotic” but a felony under federal law.

The Civil War, from 1861 to 1865, freed all Whole-Persons from such acts of performance and threat of fine or imprisonment, while extinguishing similar defect legalized under Scott vs. Sanford/Sandford. This ended the offense against those who desired to adhere to Transcript's precepts or purported Enlightenment ideals. Otherwise all Whole-Persons would have remained complicit, nationally, in perpetuating homo/heterosexual-rape or pedophilia by any Claimant, as well as wide-scale adultery practiced by Claimants under color of authority by Article IV and “divine” exemption through stare decisis of the Supreme Court.

If a Claimant were male and the PHD a female, Scott vs Sanford/Sandford similarly allowed and protected the right of a Claimant, acting under fictitious-identity as a Whole-Person, to legally engage in adultery, homo/heterosexual-rape or pedophilia with indifference to the marital/monogamous status of the Claimant of PHD. Though legal under positive law through Article IV of the Constitution, up until 1865, such a “right” was in direct conflict with Transcript's expressed prohibition, “You shall not commit adultery.” Exodus 20:14. Article IV allowed a consenting male-Claimant to sell a female PHD to another consenting male under a “divine” exemption and right to privacy.

Therefore under state property/privacy rights, inclusive of homo/heterosexual-rape or pedophilia, a consenting male-Claimant could rent-out a female PHD to another consenting male, independent of the marital/monogamous status of the female-PHD. This was settled law by stare decisis from the Supreme Court, precedent thereof being that consenting males, acting under fictitious-identity as Whole-Persons, could do the same with an ewe (female sheep) under a right to privacy. Also, under a right to privacy, a Claimant could terminate any resulting female-PHD's pregnancy, or terminate the female-PHD's life through pretext of preventing escape, if for no other reason. By stare decisis, a Claimant only needed intimate an escape attempt to justify terminating the life of a male or female PHD, or any born or unborn child thereof. Chief Justice Roger Brooke Taney wrote the majority opinion.

Such a right to privacy was settled law and respected by the Supreme Court with stare decisis in Scott vs. Sanford/Sandford and subsequent rulings thereof. The Supreme Court's right to privacy precedent under Scott vs. Sanford/Sandford continued unchecked until the Civil War, in 1861 to 1865. Subsequent wording within the 13^{th} and 14^{th} Amendments precluded any further attempt by the Court to project such a right to privacy throughout the nation. The Court would not reassert any similar right to privacy until its birth control decision in or about 1967, and its abortion ruling in or about 1973. The Court assigned a fictitious-identity to the plaintiff in its 1973 abortion decision. That party, later discarding the Court's fictitious-identity, expressed regret about the matter's outcome and ruling thereof.

Thus prior to 1865, the Supreme Court allowed expansion of fictitious-identity markets for PHDs within FID:1 states, especially when foreign rendition was prohibited after 1808, specific to any foreign person deemed to have a similar slc24a5-cipher to Canaan, whatever that might be. In essence, the Constitution's Framers' condoned a federal establishment of religion and “divine” exemption thereof, including abortion, adultery, murder, homo/heterosexual-rape, pedophilia and sexual or other forms of economic exploitation, using a single Transcript citing to construe the slc24a5-cipher as cause to predestine embryos for indefinite or life-long servitude, or their termination, by private-party fictitious-identity dicta. And that practice of embryo predestination was based, by and large, on Canaan's physical appearance, whatever that appearance might be. FID:1 states and parties therein construed Canaan as the first person on earth “divinely” assigned to indefinite or life-long servitude, identifiable by some attribute of Canaan's slc24a5-cipher, whatever that attribute might be.

The fear of the Coalition dissolving was greater than the Framers' revulsion against allowing a “divine” exemption to create fictitious-identities by private-party dicta. This led the Framers' to countenance such a precedent under positive law, along with its Billion Man-hour Entitlement, placing both within the scope of the Constitution. The intent was to remove the threat of disunion. The Framers made effort to circumscribe the Entitlement until such time it might collapse under its own defects, or allow time for the Constitution to gather to itself enough wherewithal to address, later, what was impossible to contemplate in 1787 to 1789. The intent of such compromise was to spare millions of souls from being perpetually trapped within a separate nation or nations, along with their human potential and capital generation.

Thus, the shared-security of the Coalition might remain intact, avoiding a separate or hostile nation or nations forming on the same continent while the Constitution attempted to take hold. Yet, it was a Faustian pact. From 1789 to 1860, there would be on-going attempts to expand the Entitlement into all states and territories, against the expressed wishes of the Framers that the Entitlement never become national, but remain regionally restricted as long as the Entitlement existed. And the very parties benefiting from the Entitlement would remain hostile to ideals in the Declaration of Independence. That hostility, after 72 years (1789 to 1861), would lead to violent insurrection against both it and the Constitution—the signed agreement among all the Framers by more than a ⅔rds majority.

The Transcript verses cited, by hostile parties to the Declaration of Independence and the Constitution, don't define Canaan's biogenetic make-up or physical appearance in any way whatsoever, or whether his grandfather Noah's genetic traits were predominant in ‘Canaan, or if some other traits were. Therefore, embryo-predestination by fictitious-identity dicta in some states, specific to the slc24a5-cipher, could be no more than a form of religious opinion, at best; at worse it became a predestination cult violently at odds with Jeffersonian notions of the Laws of Nature and Nature's God in the Declaration of Independence. As a kind of religious opinion, embryo-predestination by fictitious-identity dicta seemed based on a singular Transcript citing, uncorroborated by other Transcript reference or rendering of any kind.

The text shows that after Noah drank wine, he went to sleep and later awoke. Upon awaking he in fact subjected Canaan, one his own family members, to servitude. In other words, a man cursed his own progeny to servitude. That is, the events weren't set in motion by a “divine” cause but rather through an event subsequent to a lapse of consciousness after drinking wine. Upset with what his son Ham did while Noah slept, after Noah awoke he cursed Ham's newly conceived son and named him Canaan (reference: inventor's book, From Jupiter to Genesis, a world-wide first-hit title on Google, available via Amazon, Barnes&Noble, etc.). Based on this, some states in 1790—multiple millennia later—used the slc24a5-cipher's 111^{th} amino acid and Canaan's physical appearance, whatever that might be, to predestine embryos to fictitious-identities, by positive law with Article IV in the Constitution, and for indefinite or life-long servitude as a state might see to its benefit into perpetuity.

Construing an embryo or born person as FID:0 or FID:1 was allowed under federal law, though not required. The states, under Article I, Section 2, Clause 3, could construe FID:1 embryos as predestined to indefinite or life-long servitude based on the slc24a5-cipher and extant fictitious-identity religious opinions, within some states, prior to the Constitution's ratification. This aided the Constitution's acceptance and ratification, creating a general form of government acceptable to the Coalition of states. Furthermore, FID:0 embryos could be conceived in any state, while FID:1 embryos alleged as predestined for indefinite or life-long servitude could only be conceived in a subset of states actively enforcing fictitious-identity dicta by legislation from 1790 until 1865. That is, a “federal” entitlement construing embryos as predestined to indefinite or life-long servitude was, in fact, never truly “federal.”

Thus each state, for enumeration purposes under Article I, would define itself as either a FID:0 state consisting only of Whole-Persons from marriages and embryos not subject to notions of predestination and indefinite or life-long servitude; or as a FID:1 state consisting of Whole-Persons and “all other persons” from embryos and marriages legally construed as predestined for indefinite or life-long servitude through fictitious-identity dicta. FID:0 states' enumerations were uniform, with everyone thereof legally construed with fictitious identity as a Whole-Person. This didn't preclude FID:0 states' less overt fictitious-identity social engineering practices with the slc24a5-cipher, under the alleged presumption that certain embryos were predestined to marginal or second-class status. In this context for FID:0 states, the slc24a5-cipher could still be leveraged, without losing enumeration advantages for federal representation and resource allocation, by construing all parties as having “Whole-Persons'” fictitious-identities. Once establishing patterns of fictitious-identities under positive law, those patterns may perpetuate themselves, even after such positive law becomes void, whether at the state or federal level. A nation's genetic demographics will evidence suck law existed through patterns of legalized “national favoritism” later construed as informed exclusively by “merit.” Germany destructively embraced such “national favoritism” with fanatical fervor in the 20^{th} century.

Such precedent of fictitious-identities, and Entitlement legalized even for a limited period from 1789 to 1865 in the U.S., perpetuated far beyond removal of the laws setting them in motion. Embryo-predestination based on Canaan's slc24a5-cipher characteristics, whatever they might be, distorted free-market forces after the Civil War to the end of the 19^{th} century, and from the 1900s to the 1930s, then to the 1950s, then to the 1980s and into the 21^{St} century. The attributes of Canaan's slc24a5-cipher, whatever they might be, will continue to inform laws, culture, and legacy patterns through “divine” exemption and favoritism that became expedient under the Constitution, in spite of the Declaration of Independence. Yet the expediency of fictitious-identity dicta opened a Pandora's box of legalized adultery, murder, homo/heterosexual-rape, pedophilia and sexual or other forms of exploitation for monetary gain. And the “wages” thereof compounded, like interest, state by state, in the legacy of Claimants and fellow believers desiring to perpetuate what the Framers did everything in their power to contain, later costing some 670,000 lives, 1861 to 1865, with personal loss, suffering, impairment and premature death encompassing tens of millions more.

[We shall see what Claimants desired to the point of risking destruction of an entire nation, rather than respecting the Framer's regional restriction on fictitious-identity dicta and Entitlement thereof, would be pursued, later, by foreign fellow believers of Claimants. This would lead to loss of life in the 20^{th} century exceeding 60 million living souls worldwide. That number is roughly equal to the entire population of the Roman Empire, including the family and child thereof linking Rome's 1^{st} century A.D. census with the 603,550-man census some 12 centuries prior. And of those 60 million, fictitious-identity dicta would be used to murder some 6 million descendants from the 603, 550-man census, in an attempt to remove all vestiges, remnant and legacy that those 603,550 men, their wives, families and children ever existed on earth. As with any attempt to predestine the born, by fictitious-identity dicta, it failed in no uncertain terms, the lives of billions not born as witness to each depravity visited upon mankind.

[From Transcript, such fictitious-identity dicta will always be attempted in opposition to well-established precedent and written precepts, principles and pedagogy, under heaven, encompassing Assyria, Babylon, Persia, Rome, modern nations and empires that may assert any similar “divine” exemption regarding embryo-predestination to allow adultery, murder, homo/heterosexual-rape, pedophilia and sexual or other form of exploitation for monetary gain. Today, dicta-nations globally may, perhaps, attempt to embrace what dicta-states attempted within the U.S. The global macromodel is just as defective and pernicious as the micromodel that failed under the Framer's constraints on the U.S. Constitution from 1789 to 1865—whether the macromodel is applied with China, Asia, Southern Asia, Russia, the Middle East, Africa, Europe or the Western Hemisphere as components within a neo-macromodel

The Framers provided powerful incentive for every state to be a FID:0 state, since there was a 100% benefit for purposes of representation and revenue apportionment if every person in a state were counted a Whole-Person, independent of his or her slc24a5-cipher status. On the other hand, FID:1 states would never enjoy a similar 100% benefit of apportioned resources and representation. Their apportioned benefit would always be less than that for an equal number of persons in a FID:0 state. For enumeration purposes, everyone in a FID:0 state was construed a Whole-Person. No one therein was predestined for indefinite or life-long servitude based exclusively on the slc24a5-cipher or any other attribute an embryo might have at conception.

Additionally, free market forces favored FID:0 states in a number of ways. Foremost were natural incentives intrinsic to innovation and increasing output of manufactured products and hard goods that were less bound by price elasticity of almost all agrarian commodities. Technological innovation, patents and know-how advancement were nurtured when labor and capital move more freely among emerging markets to maximize prosperity and new opportunity thereof, and less so where free market conditions are impaired by fictitious-identity dicta and pathological propensities it may engender and allow.

Furthermore, FID:0 states tended to disproportionably attract domestic migrants as well as foreign immigrants, independent of each person's slc24a5-cipher, offering an “unfettered start” not easily matched by FID:1 states. Better-educated and entrepreneurially-minded individuals might more readily access opportunity and infrastructure apparent through FID:0 free market conditions. When possible, PHDs migrated to FID:0 states, even at considerable personal risk. Such risk included murder, brutal torture, disfigurement, as well as physical and sexual abuse from any attempt to disregard a state's enforceable fictitious-identity dicta and predestining embryos for indefinite or life-long servitude, based on the slc24a5-cipher, provisioned by Article IV for FID:1 states.

The desire for shared-security among the Coalition states, within their contiguously joined borders, was one reason the Billion Man-hour Entitlement was encoded within the Constitution. Benjamin Franklin noted, “They who would sacrifice liberty for security deserve neither liberty nor security.” Thomas Jefferson recognized the Entitlement's favoritism was at extreme odds with the Laws of Nature and Nature's God, saying, “I tremble for my country when I know that God is just.” The fact that George Washington, Thomas Jefferson and other prominent figures publicly availed themselves of the Entitlement reduced any suspicion, allowing the Constitution to peacefully go into effect.

Moreover, the states benefiting from the Billion Man-hour Entitlement accepted the regional restriction on it, since in an agrarian society a billion man-hours of uncompensated labor provided a tremendous advantage over other Coalition states where the Entitlement was prohibited. Implementing the Billion Man-hour Entitlement under the Constitution left open expanding its precedent of fictitious-identity by dicta, binary from its inception, religious in its justification, and economically exploitative in practice. For census purposes under Article I, Section 2, Clause 3, every living person throughout the United States would be codified as FID:0 or FID:1 —Whole-Person or PHD, the latter construed by dicta as predestined to life-long or indefinite servitude at conception.

Based on defective use of Transcript, the slc24a5-cipher was “divinely” construed to determine if a particular marriage were recognized by the state or not recognized by the state. If not recognized by the state, a marriage, parties and embryos thereof were legally construed as predestined to indefinite or life-long servitude to the benefit of the state. However, using a biogenetic-cipher to predestine an embryo's existence to the benefit of any state or nation, or termination of said embryo to the benefit of any state or nation, based on any biogenetic trait, had profound historical ramifications, as noted previously from a Transcript citing:
The king of Egypt said to the Hebrew midwives, whose name were Shiphrah and Puah, “When you help the Hebrew women in childbirth and observe them on the delivery stool, if it is a boy, kill him; but if it is a girl, let her live.” Exodus 1:15,16

In this case, by state authority embryos were predestined for termination at birth, based on a biogenetic-cipher specific to their common Y-chromosomes—embryos already subject to life-long or indefinite servitude through ancestral linguistics and residential identity cipher (the region of Goshen) by a previously issued state edict. The edict became binding at conception, to be carried out upon the birth of each designated child. Embryos of the same linguistic ancestry with two X-chromosomes were exempt from the death edict. According to Transcript account, predestining embryos to life-long servitude did not, in and of itself, bring divine retribution upon the state, in this case Egypt. However, predestining embryos to death, by a decree based on a linguistic ancestry and residential cipher, or any biogenetic characteristic determined at conception, intruded upon and severed the bond through marriage and birth between parents and offspring. And the intrusion upon that bond, even after 400 years of servitude, invoked divine wrath in short order—a pedagogical event reverberating within virtually every nation on earth today:
At midnight, the [I-SHALL-BE] struck down all the firstborn in Egypt, from the firstborn of Pharaoh, who sat on the throne, the firstborn of the prisoner, who was in the dungeon, and the firstborn of all the livestock as well. Pharaoh and all his officials and all the Egyptians got up during the night, and there was loud wailing in Egypt, for there was not a house without someone dead.
   Exodus 12:29,30.

According to Transcript, one of these Y-chromosome embryos later became a born person and survived the state death-edict. He went on to conduct the first divinely authorized census on earth:
Then Pharaoh's daughter went down to the Nile to bathe, and her attendants were walking along the river bank. She saw the basket among the reeds and sent her slave girl to get it. She opened it and saw the baby. He was crying, and she felt sorry for him. “This is one of the Hebrew babies,” she said.
   Exodus 2:5,6
. . . She named him Moses, saying, “I drew him out of the water.” Exodus 2:10
The [I-SHALL-BE] spoke to Moses in the Tent of the Meeting in the Desert of Sinai on the first day of the second month of the second year after the Israelites came out of Egypt. He said, “Take a census of the whole Israelite community by their clans and families, listing every man by name, one by one.”
   Numbers 1:1,2

There was no discernible, divine consequence centuries later, in America, from creating fictitious-identities to count every million Whole-Persons as one million living souls, and every million PHDs as 600,000 living souls for census purposes between 1790 and up to the mid-1860s. This allowed the non-federal basis of the Billion Man-hour Entitlement to perpetuate within its geographic restrictions through a subset of states, and never in all the states. However, there were adjustments needed from time to time to maintain some sense of representative balance between FID:0 and FID:1 states.

The 1820 Missouri Compromise reaffirmed the never-to-be-national basis of the Billion Man-Hour Entitlement, consistent with the expressed wishes and consensus of the constitutional Framers. The Missouri Compromise helped extend the Entitlement's geographic restrictions into the Louisiana Purchase territories, those territories encompassing lands acquired from France under Napoleon in 1803 during Thomas Jefferson's presidency.

By 1824, only four years after the Missouri Compromise, Congress voted to double the average federal tariff rate from 10-15 percent to 20-30 percent. A “revenue tariff” of 10-15 percent was accommodated by FID:0 and FID:1 states, providing funding for the federal government's operation. However, a tariff beyond these rates tended to favor FID:0 states while being burdensome, and even punitive to FID:1 states. FID:1 states were primarily agrarian-based and relied on imports of manufactured farm tools, certain textile based products, and a host of other manufactured items. In general, these were imported from FID:0 states or foreign nations.

High tariffs tended to protect manufactured-goods markets of FID:0 states from international competition. With comparatively less manufacturing capacity, high tariffs produced a net increase in prices to FID:1 states for essential items, whether sourced from domestic or international manufacturers. The Henry Clay-sponsored tariff bill of 1824 magnified FID:1 states' excessive dependence on the Billion Man-hour Entitlement for agricultural production, as well as those states' lack of free market diversification. A tariff, therefore, came to represent a transfer of wealth out of FID:1 states, through the central government, to FID:0 states, nullifying or significantly degrading any presumed regional advantage sought with the Billion Man-hour Entitlement. The idea, by the Whig Party at the time, was to use additional revenue from high tariffs for “internal improvements.” In reality, these acted as subsidies to corporations, primarily within FID:0 states. The tariffs justified altering national banking regulations to “manage” and leverage funds accumulated through high tariffs in conjunction with other federal revenue sources. Even though federal tariff regulation aimed to advantage domestic manufacturing industries against international competition, FID:1 states could not similarly benefit from such federal regulation. And FID:1 states took strong exception to these inequities. The economic favoritism they hoped to enjoy, perpetually under the Constitution and the Billion Man-hour Entitlement, proved elusive. Through tariffs, FID:1 states were subordinated to FID:0 states and to their industry and free market forces that better attracted and treated labor. This outcome was not entirely unexpected by the constitutional Framers when the Billion Man-hour Entitlement was restricted to a subset of states and never allowed to be national.

The slc24a5-cipher through Article I, Section 2, Clause 3 became a de facto tool to identify states which were economically out of step with free market ideals, and states at odds with diversifying the national economy into internationally competitive manufacturing industries. FID:1 states typically exported three-fourths of everything produced, especially cotton, tobacco, and rice. The prices of these commodities were always exposed to international competition. This was much less so for manufactured goods originating from FID:0 states. The tariff of 1832 further exacerbated FID:0/FID:1 differences, based on FID:1 states' Entitlement-dependent economies which emphasized commodity crops rather than manufactured goods.

By the late 1850s, the Entitlement region had amassed some $0.5 billion in debt through borrowed funds from New York and other banks outside the Entitlement region, even while exploiting the constitutionally granted Billion Man-hour Entitlement for some 60 years. Special-interests within FID:1 states realized that unless the Billion Man-hour Entitlement were extended throughout all states and into other markets besides agricultural production, their $0.5 billion debt would only increase. By extending it nationally, the Entitlement could impair and undermine free market industrial and labor advantages in FID:0 states. Efforts to this end were set in motion on the federal level, including the Compromise of 1850 (herein the “1850 Fictitious-Identity Rendition Act”) regarding proactive federal enforcement of Article IV, Section 2, Clause 3, in all states, specific to:
No person held [by fictitious-identity dicta or] to service or labor in one state, under the laws thereof, escaping into another, shall, in consequence of any law or regulations therein, be discharged from such service or labor, but shall be delivered up on claim of the party [Claimant] to whom such service or labor may be due.
   Article IV, Section 2, Clause 3

Senator Stephen Arnold Douglas (1813-1861) led the effort to pass The 1850 Compromise and its 1850 Fictitious-Identity Rendition Act, to make Whole-Persons in FID:0 states liable and punishable for negligence regarding any loss of work or service enforceable by fictitious-identity dicta under the Billion Man-hour Entitlement. In other words, a Whole-Person in a FID:0 state could be prosecuted for a FID:1 party's perceived or actual loss under the Billion Man-hour Entitlement and its related fictitious-identity dicta. Negligence could encompass even being aware of such loss, whether perceived or real. The 1850 Fictitious-Identity Rendition Act made individual FID:0 citizens, rather than just FID:0 states, liable and prosecutable for reasonable suspicion of such negligence under Article IV. This was a radical departure from sovereignty granted states to enforce their own laws, especially FID:0 state laws. The 1850 Fictitious-Identity Rendition Act in essence changed Article IV's wording that a PHD “shall be delivered up on claim” to “shall be delivered up independent of claim.” And all Whole-Persons in a FID:0 state could come under suspicion for prosecution if a PHD entered a FID:0 state, even if no one in the FID:0 state knew the PHD were there.

Creating such a federal liability, where none existed before, represented a key step to nationalizing the Entitlement in all states. Before The 1850 Fictitious-Identity Rendition Act, a fictitious-identity dicta could be used to claim a PHD, but this might involve a due process proceeding in a FID:0 state court, unlike in a FID:1 state court. There was no national ID system for PHDs other than that based on the slc24a5-cipher and fictitious-identity dicta claims by Claimants. However, unlike FID:1 states, all parties in a FID:0 state were presumed Whole-Persons, independent of their slc24a5-ciphers' 111^{th} amino acid. Under state and federal law, therefore, the burden of proof was on the party making the claim and not upon the presumed Whole-Person. The 1850 Fictitious-Identity Rendition Act represented an important step on the way to nationalizing the Entitlement by bringing under suspicion for prosecution individual citizens in every FID:0 state perceived as negligent in identifying who was and was not a Whole-Person. FID:1 states needed no such enforcement provisions within their state constitutions.

The Supreme Court became complicit in the last step to demur the Framers' expressed intent to never nationalize the Entitlement. A nationalizing effort would implicitly establish a fictitious national ID system based on the slc24a5-cipher. The Missouri Compromise had been repealed by 1854 and would be ruled unconstitutional in the 1857 case, Scott vs. Sanford/Sandford. By fictitious-identity dicta, Dred Scott, from conception and later birth, had been construed as predestined to indefinite or life-long servitude, under Missouri law as a FID:1 state. By dicta and Article IV, a U.S. Army surgeon, Mr. John Emerson of Missouri, using the fictitious-identity of a Whole-Person, availed himself to the Billion Man-hour Entitlement through claim that Mr. Dred Scott was subject to fictitious-identity dicta as a PHD. All witnesses, including John Emerson, affirmed Mr. Scott performed services in good faith and with all due deference to dicta under Article IV and Missouri's state as a FID:1 state.

In or about 1834, Mr. Emerson relocated himself and Mr. Scott to Illinois, a FID:0 state wherein all parties' fictitious-identities were as Whole-Persons under the state constitution. Later, Mr. Emerson relocated himself and Mr. Scott to the Wisconsin Territory which was a FID:0 territory under federal law. In or about 1838, Mr. Emerson relocated himself an Mr. Scott back to Missouri. In or about 1846, Mr. Emerson died. The subsequent case, Scott vs. Sanford/Sandford, heard by the Supreme Court, attempted to decide if fictitious-identity dicta were truly federal in scope. That is, did a fictitious-identity as a PHD within a FID:1 state dissolve if a Whole-person claiming dicta—rights knowingly allowed a PHD to live in a FID:0 state or territory for any period of time?

Thus, the census provision enabling fictitious-identities for enumeration purposes, memorialized in the Constitution, set a collision course with fundamental precepts that, according to the cited Transcript, are immutable, inalienable, transcendent, and above positive law. Furthermore, according to the cited Transcript, there were at least two nations which historically challenged the cited precepts prior to 1790. Those two nations employed the power of the “state” to interfere with the union of a husband, wife and offspring thereof through fictitious-identity assertions. The destruction of both those states is part of mankind's enduring pedagogy and testimony to the profound consequences of exercising state authority in this fashion. For example, the Hebrew people were enslaved 400 years in Egypt. Yet heaven did not intervene during those 400 years due to economic exploitation alone. At the end of the 400 years, the following event triggered heaven's swift intervention:
The king of Egypt said to the Hebrew midwives, whose names were Shiphrah and Puah, “When you help the Hebrew women in childbirth and observe them on the delivery stool, if it is a boy kill him; but if it is a girl, let here live. Exodus 1:15,16
At midnight, the [I-SHALL-BE] struck down all the firstborns in Egypt, from the firstborn of Pharaoh, who sat on the throne, to the firstborn of the prisoner, who was in the dungeon, and the firstborn of all the livestock as well. Exodus 12:29

Prior to these events in Egypt, four kings were warned not to defile the union heaven allows between a husband and wife. Two kings listened and their kingdoms were spared. Two others did not and they and their kingdoms were destroyed. The following is written about the two who listened:
And when Pharaoh's officials saw [Abram's wife], they praised her to Pharaoh and she was taken inside his palace. He treated Abram well for her sake, and Abram acquired sheep and cattle, male and female donkeys, menservants and maidservants and camels. But the [I-SHALL-BE] inflicted serious diseases on Pharaoh and his household because of Abram' s wife Sarai. Genesis 12:15-17
Then Pharaoh gave orders about Abram to his men, and they sent him on his way, with his wife and everything he had. Genesis 12:20
But God came to Abimelech in a dream one night and said to him, “You are as good as dead because of the woman you have taken; she is a married woman.” Genesis 20:3
Then Abimelech brought sheep and cattle and male and female slaves and gave them to Abraham, and he returned Sarah his wife to him. Genesis 20:14
Then Abraham prayed to God, and God healed Abimelech, his wife and his slave girls so they could have children again, for the [I-SHALL-BE] had closed up every womb in Abimelech's household because of
Abraham's wife Sarah. Genesis 20:17:8

The two kings who did not listen were Bera king of Sodom and Bersha king of Gomorrah. Their entire kingdoms were afflicted such that natural relations between men and women became impossible. Yet the physical desire for such former relations remained:
Abram lived in the land of Canaan, while Lot lived among the cities of the plain and pitched his tents near Sodom. Now the men of Sodom were wicked and sinning greatly against the [I-SHALL-BE].
   Genesis 13:12, 13
[Abram] recovered all the goods and brought back his relative Lot and his possessions, together with the women and the other people.
   Genesis 14:16
The king of Sodom said to Abram, “Give me the people and keep the goods for yourself.”
   Genesis 14:21
Then the [I-SHALL-BE] said, “The outcry against Sodom and Gomorrah is so great and their sin so grievous that I will go down and see if what they have done is as bad as the outcry that has reached me. If not, I will know.”
   Genesis 18:20,21
Before they had gone to bed, all the men from every part of the city of Sodom—both young and old—surrounded the house. They called to Lot, “Where are the men who came to you tonight? Bring them out to us so that we can have sex with them.” Genesis 19:4,5
With the coming of dawn, the angels urged Lot, saying, “Hurry! Take your wife and your two daughters who are here, or you will be swept away when the city is punished.” Genesis 19:15
By the time Lot reached Zoar, the sun had risen over the land. Then the [I-SHALL-BE] rained down burning sulfur on Sodom and Gomorrah—from the [I-SHALL-BE} out of the heavens.
   Genesis 19:24
So when God destroyed the cities of the plain, he remembered Abraham, and he brought Lot out of the catastrophe that overthrew the cities were Lot had lived.

Genesis 19:29

Fictitious-identity dicta, under state authority, that intrudes upon the covenant of a husband, wife and offspring thereof, is of no less consequence today. The use of fictitious-identity dicta and census ciphers have been designed to advance civilization. In practice, the historical record is mixed regarding the secular use of these powerful governing metrics. They are now given context in light of modern technology and the widespread use of fictitious-identity ciphers in the 21^{st} century.

The Modern Use of National Ciphers with Fictitious-Identities

The World Book Encyclopedia defines a modern census” as, 1) complete or inclusive of all persons; 2) direct in that a government must interview each person individually; and 3) periodic or recurring at a regular interval. For the time being, the definition of a modern census precludes a “world census” of any kind, since no governmental entity has ever, in world history, had authority to directly count every living soul on earth. At present, this can only be done by proxy, if at all, within some nations. Only a future leader of some ill-defined international empire might attempt this.

In or about August, 1790, after winning its seven-year War of Independence from England between 1775 and 1783, and ratifying the Constitution in 1789, the U.S. attempted the first modern census. Its population was within the territories east of the Mississippi, north of Florida's boundaries, south of British North America, and lands west of, and including its original 13 founding states on the Atlantic coast. That census lasted 18 months, counting fewer than four million people. The census ciphers processed in this and subsequent decades resulted in new metrics to help regulate and oversee the growth of the emerging nation. The demographic dynamics of states, and various groups within states became discernable decade by decade, as well as migration patterns and concentrations of labor, industry, academic and other resources, all through metrics from census ciphers.

Manually processing census ciphers and metrics thereof, over time, changed forever after the U.S. set in motion the first modern census in 1790. Only 10 years earlier, in 1780, Luigi Galvani, an Italian physician, unknowingly discovered galvanism, or using two metals in a moist environment to produce an electric current. By the late 1790's Italian scientist Alessandro Volta used galvanism to create the first practical battery. In 1820 Hans Christian Oersted, a Danish physicist, used an electric current to cause a magnetized needle to move, discovering the relationship between electric currents and magnets. This led to a number of primitive telegraphic devices in England and other countries. By 1825, William Sturgeon made an early electromagnet, which the American physicist Joseph Henry significantly enhanced five years later and used in a telegraph experiment. Henry's crude telegraph sent signals over more than a mile. In 1837, Henry designed primitive amplifiers to boost an electrical signal to increase transmission distances.

Englishman William F. Cooke and Charles Wheatstone combined five electromagnetic-controlled needles, each with its own wire. They transmitted messages from one location using electric pulses which made the needles point to specific letters at the receiving location. Their invention was awarded an 1837 patent in England and was later refined to a single needle with only one wire. In that same year, American inventor Samuel F. B. Morse made the first practical telegraph.

Mr. Morse started researching his invention in 1832, and subsequently designed a code based on a group of ciphers to represent letters. Alfred Vail helped refine the code as simple dots and dashes. Shorter sequences, or a single dot or dash, represented the most frequently used letters. Vail also helped Morse innovate a sending and receiving device called a “key.” An operator moved a lever up and down, varying the length of time a circuit was closed or opened. This produced patterns of dots and dashes heard as varying clicks at a receiving station. An electromagnet's attraction of a metal bar reproduced the clicks of varying duration, corresponding to the dots and dashes. The part of the apparatus called a “sounder” received signals from the sending key. Alternately, a suspended pencil in a frame could be deflected by an electromagnet to record patterns of dots and dashes on paper tape.

Later, in 1840, Mr. Morse received a U.S. patent for the first practical telegraph in the world and the unique code of dots and dashes Alfred Vail helped design to represent numbers and letters. Vail's innovations for a combined sending and receiving key were included in the patent. After 1843, the federal government went on to provide substantial funds to create a network for transmitting discretely coded information between telegraph sites, that code being the one patented by Morse. In 1848 The Associated Press was formed by six New York City newspapers to pool expenses for gathering and distributing news by telegraph. Three years later, in 1851, German businessman Paul Julius Reuter founded a telegraph service, which became Reuters, to provide financial news between European markets, financial and other institutions.

By 1883 a worldwide network was composed of telegraph lines and cables, both over land and under the seas. This network interconnected every major capital and city on earth. In August of that year, a massive volcano eruption killed some 36,000 people near Krakatau (or Krakatoa), an Island in Sundra Strait of Indonesia. It generated 40 meter (130 feet) waves, which caused most of the fatalities, along with ejecta and volcanic ash. The ash literally encircled the entire earth, lowering the temperature in parts of the world. The eruption could be heard some 3,000 miles away and created a shock wave that circled the earth seven times, recorded by barometers in world capitals.

The news agencies interconnected through the worldwide telegraph network made Krakatau the first event in human history reported throughout the whole world within only 48 hours of its occurrence. The worldwide telegraph network included the Lloyds of London office in Indonesia which monitored insurance risks for shipping lanes in that part of Asia. These included lanes used by the Dutch East India Company for sending cinnamon, clove, nutmeg, and other cargo bound for Europe. The worldwide telegraph network of the 1880's was a primitive precursor to what became the Internet 100 years later in the 1980's. The Internet anticipates recovery from any event causing wide-scale devastation, whether by war, nature or other means.

As we will see, the telegraph and later the worldwide network it helped spawn is one of two enabling technologies for creating the present-day worldwide financial infrastructure, vulnerable to $50 billion in annual fictitious-identity transgressions. The other enabling technology, also patented first in the U.S., grew out of processing census ciphers. At the start of the 20^{th} century, data encoding, data transmission, and data processing would be sufficiently developed to establish fictitious-identity ciphers for every living soul in the U.S. By the end of the 20^{th} century, technology would make it possible to do so for every living soul on earth.

In its 1890 census, the U.S. became the first government on earth to use electricity to automate a census, achieved through what became a worldwide technological break-through. That break-through was called a punch-card-tabulating machine. America's 1880 census had taken nine years to manually process, and would take even longer in 1890 without some type of automation. The punch-card-tabulating machine would become the tool of choice for world governments to process macroeconomic ciphers down to the microeconomic identity of individuals. Again, this was all an outgrowth of Article I, Section 2, Clause 3 of the Constitution, requiring a decennial national census no matter the size of the U.S. population.

The census tabulating machine's inventor was Herman Hollerith, a U.S. citizen and son of German immigrants. He graduated from Columbia College in 1879 whereupon he worked at the U.S. Census Bureau. There he came to appreciate that manually counting an analyzing America's ever-increasing population metrics would soon be impossible to complete before the next decennial census began. John Shaw Billings, Director of Vital Statistics at the Census Bureau, suggested to Hollerith and others the idea of mechanizing, somehow, the tallying of census data.

Various types of information storage media were in use at the time, ranging from cards and paper tape with punched holes, to metal cylinders with studs arrayed across their surfaces to represent musical notes. Hollerith knew of these types of storage media. Joseph Jacquard invented the automatic pattern loom in 1801 for example, which used cards to produce intricate patterns on cloth. Music boxes employed rotating metal cylinders to repeatedly play a tune. And player pianos could “read” holes in paper rolls to reproduce multipart musical pieces. Charles Babbage, in or about the 1820s, invented the idea of a stored-programmed computer. He, too, was aware of the Jacquard loom and thought of using punch-cards for automating calculations.

With John Shaw Billings' encouragement Herman Hollerith considered how a paper storage media and electricity could be combined to represent and tabulate demographic data. Thus, a U.S. government agency infused into one of its own employees the seed-idea that would later spawn a worldwide monopoly on punch-card tabulators and sorters. The government wouldn't make a penny on the resulting patents but would later pay considerable sums of money over multiple decades to use the technology, as well as buying billions upon billions of punch-cards these machines required for various government applications.

Hollerith left the Census Bureau in 1882 when General Francis Walker, president of the Massachusetts Institute of Technology, invited him to become an instructor at MIT. General Walker had previously worked at the Census Bureau himself and met Hollerith while there. At MIT Hollerith began to seriously work on the invention he and Billing discussed. Hollerith initially considered thin rolls of paper tape as a medium. He thought of feeding punched paper tape between a row of sensing pins and a metal bar. Different sensing pins' paths activated parallel electric circuits, depending where holes were punched across the tape's face and which pins, above the paper tape, made contact through the holes to the metal bar. Each circuit completed by a hole or holes advanced a specific mechanical counter to display a particular population metric being tabulated.

In 1883, a train ticket Hollerith purchased for a westward train ride led him to reconsider and significantly change his machine's design and media format. The train ticket was a stiff, rectangular card that allowed its purchaser's biometric profile to be punched on the card's edge, including gender, eye color, hair color, nose shape, height and other physical characteristics. Railroad personnel used the “punch photograph” to make sure a ticket's presenter was indeed its purchaser, since each potential reuse or misuse of a discounted “multi-stop transfer” ticket, by a different party, represented lost revenue to a railroad. Reusing such a discount ticket constituted an early form of FICTITIOUS-IDENTITY TRANSGRESSION. The biometric profile punched on a train ticket's edge virtually eliminated a railroad's losses from such transgressions.

Hollerith seized on the idea of a “punch photograph” as a possible way to address the census problem. What helped protect railroad revenues in the late 19^{th} century would later, along with a national cipher and the evolution of the worldwide telegraph network, opened the way for systems enabling FICTITIOUS-IDENTITY TRANSGRESSION losses by banks and other financial institutions, exceeding billions of dollars every years in the early 21^{st} century.

In Hollerith's adaptation of the “punch photograph,” a blank “punch-card” was encoded by a keyboard operator from a tally sheet a census taker filled in by hand. The tally sheet contained a person's answers to a census questionnaire. A keypunch operator transferred the person's census responses from the tally sheet to a card by punching holes, not along a card's edge, but rather using a template to punch holes into unique locations on the face of the card, each location representing a different demographic attribute. With a stylus, the operator made one punch for gender, one punch for race, one punch for immigration status, one punch for marital status, one punch for state of residence, and so forth, each in a defined location on the card. A “tabulating machine” would “read” the pattern of holes in each card with a “pin box” carefully placed over the face of each card. The “pin box” was a grid of metal contacts much like a small, square bed of nails. By pressing the “pin box” down on each card's face, the holes in a card were electrically registered, triggering an array of parallel circuits and their corresponding counters, each connected to a specific pin for the defined demographic attribute of a hole or holes in a card's face.

Afterwards, the cards were fed through another machine to sort them into 26 different hoppers, each hopper specific to a selected punch or punches on a card's face. The sorted cards might then be fed through the sorters repeatedly to recount a specific subpopulation based on selected criteria. Such sorting/tabulating cycles could be done repeatedly to statistically measure any demographic attribute of interest, even down to small groups of individuals, if not a single individual in some cases. It became possible to know how many females (one punch) of a specific European descent (one punch), had immigrated (one punch), and were not married (one punch), yet lived in New York (one punch) and were under 30. Numerous variations of these types of demographic inquires could be processed just as readily.

Hollerith abandoned his academic career to work full-time on his invention. By 1884 he had his first patent that far surpassed efforts by others like Charles Pidgin and William Hunt, who were attempting to develop their own solutions to automate census processing. In fact, Hunt was an executive at the Census Bureau and member of the selection committee for mechanizing the bureau's counting methods. The Hollerith machines performed well enough in the 1886 Baltimore census that New York and New Jersey ordered them for tabulating mortality statistics. By 1889 Hollerith received three additional patents and went on to win the federal contract for the 1890 U.S. census over alternative bids by Hunt and Pidgin.

With Hollerith's solution, the 1890 census was completed in only two years, for all 62,622,250 Americans. This represented approximately 4% of the world's population at the time, or approximately the population of the entire Roman Empire around the 1^{st} century A.D. Once the information was encoded, its processing took only six weeks. Census superintendent Robert Porter gave Hollerith all the credit for the success and speed of the census. Porter spent $750,000 to rent Hollerith machines, while saving an estimated $5 million in labor costs. Furthermore, the statistical analysis and metrics from the census data far surpassed anything possible before. U.S. Commissioner of Labor Carroll Wright also acknowledged strategic competitive advantages, nationally, from the 1890 census's comprehensive statistical analyses of the country's vast labor and internal resources.

Among the 62,622,250 people counted in the U.S., roughly corresponding to the population of the Roman census some 1,876 years before, were descendants for the 603,550 men of the first divinely authorized census under heaven, according to the previously cited ancient manuscript. These 603,550 men were counted centuries before Rome's founding by two brother's named Romulus and Remus, nursed from infancy by a she-wolf according to oral legend.

Nation-scale social planning and resource management possibilities, from a modern census with Hollerith technology, were not lost on the rest of the world in 1890, after the stunning success by the U.S. government. Like dominoes falling into line, other major nations followed the U.S.'s lead and leased or purchased census tabulating machines from Hollerith. He would go on to hold a worldwide monopoly on the technology through U.S. and foreign patents. Leasing was Hollerith's preferred way of doing business. In late 1890, Austria ordered machines for its census. In 1891, Canada followed, ordering five machines. And more European countries acquired the machines to garner the competitive advantages of better organizing their populations and managing resources. Russia, which had never conducted a census since its origin in the 800s, used Hollerith machines for its first-ever census in the 1890s.

Wherever these machines were leased or purchased, a steady stream of blank punch-card orders followed, just as blades might be repeatedly bought to refill razors or film for cameras. In 1895, alone, Hollerith sold 100 million cards, not all just for government census use. The tabulators offered tantalizing possibilities, even for demographically profiling small, specific communities of people. In fact, statistically interesting groups of people could be distinguished, no matter how tiny their numbers. It was just a matter of repeatedly sorting and tabulating the punch-cards for a desired result. Even in 1890, these antiquated machines were fast enough to perform a variety of sorts in reasonably short order, no matter how arcane or repetitive the sorts. Such functionality would have far reaching consequences for the entire world less than half-way through the 20^{th} century which would begin in 1901, only 10 years later.

The 1890 and 1900 censuses were foundational to what would become the Y2K problem in 2000. (Special note: 1900 did not have a February 29^{th}). The year-field on punch-cards were abbreviated to two digits. Adhering to this two-digit precedent throughout the 20^{th} century led to panic of widespread computer failures as 2000 approached. Patent #6,236,992, also known as BEST2000A™ by the inventor of the present art, allowed IBM computers in seven countries to be encrypted and made immune to Y2K failures. Even for an IBM system with 1.2 million lines of customized code, the encryption could be done in as little as six weeks. Those systems worked without any production disruption whatsoever due to Y2K, and are programmed to do so through 2025 and beyond if necessary.

By diversifying punch-card application into the private sector, Hollerith supplemented cyclical census business, expanding his lease/purchase base for his machines in off-census years. Railroads, insurance companies, wholesale and retail merchandisers, among others, became ready and willing commercial users. They, too, appreciated competitive advantages tabulators and sorters brought, especially for analyzing volumes of business data against metrics driving profitability. In 1896, Hollerith incorporated himself as the Tabulating Machine Company, or TMC, a New York concern. TMC maintained its headquarters in Washington, D.C. near the firm's first, major client, the Census Bureau. By 1905 Hollerith reincorporate in New Jersey, the same year Einstein introduced the Theory of Relativity that would lead to the development of atomic energy which Hollerith tabulator. technology would be instrumental in helping weaponize in the 1940s.

The commercial use of Hollerith machines in 1908 for billing applications helped bring low-cost electricity to the masses, along with replacement of fire-prone gas lamps with electric light bulbs instead. Tabulators, which processed metered data, helped implement an innovative dual-rate billing structure for electric utilities, lowering the cost per watt to mass-distribute electricity while maximizing utilization and profit of power generation equipment. This low-price/mass-produced power model was first applied in the U.S. by Mr. Sam Insull, the business genius and right-hand man to Thomas Edison the inventor, which led to the electrification of the entire nation in the early 20^{th} century. Very affordable, universal electricity helped expand use of all manner of electrical and electric-motor driven equipment, including tabulators, sorters, machine tools, factory equipment, as well as home appliances like refrigerators, irons and a host of other electric-powered conveniences.

Even as Hollerith was hailed throughout the U.S. and around the world as an inventive genius, all was not well in his business dealings. Storm clouds gathered on the horizon, especially regarding future contracts for the 1910 U.S. census. Hollerith was always suspicious that his customers might steal his designs. Additionally, cash flow shortages occurred from his preference to lease equipment, instead of outright sales. And finally, Hollerith was not always the most pleasant person with whom to work; he did not have a winning personality when it came to business, sales and marketing. So long as there were no competitors, Hollerith could treat his customers anyway he liked and conduct business on his own terms.

Not long after the 1900 census, which Hollerith won from the U.S. Census Bureau, a new director, Mr. Simeon N.D. North, discovered Hollerith had been price-gouging the U.S. government while offering much more favorable terms to foreign governments and commercial enterprises. The price-gouging and contracts allowing it were made under the previous director, William Mirriam, whom Hollerith made TMC president after Mirriam left the Census Bureau. The confluence of these events reflected very poorly on the U.S. Census Bureau and its management, which North proceeded to remedy.

Hollerith disagreed with North's reform efforts and oversight. However, time was on North's side. In 1906, with the expiration of Hollerith's patents, the Bureau could solicit bids from multiple suppliers. A Census Bureau employ named James Powers felt he could produce better machines than Hollerith's, having studied their use in the 1900 census. Rather than Hollerith's restrictive leases, Powers would sell his machines outright to the Bureau at considerable savings. Additionally, Powers agreed to supply punch-cards at steep discounts compared to Hollerith. It was no wonder that North later awarded the 1910 census contract to Powers.

Even Hollerith's subsequent 1910 infringement suit against North and the Bureau could not stop the inevitable, since the Hollerith patents expired in 1906. And Powers's machines were faster with better features. To make matters worse, Hollerith berated North before Congress and to President Theodore Roosevelt who had appointed North. There was no turning back. Hollerith's arrogance had decimated his relationship with the very government agency that helped spawn his wealth and worldwide frame. The decline of TMC after these events ultimately led Hollerith to sell his firm.

In 1910, he began doing this incrementally, including licensing his tabulator patents to Willy Heidinger in Germany, who formed Deutsche Hollerith Maschinen Gesellschat, or German Hollerith Machine Corporation. “Dehomag” was owned by Heidinger and paid royalties to TMC as well as a percentage of revenue from sales. Following Hollerith's practices, Heidinger leased machines to government and private sector customers in Germany.

By 1911, Hollerith sold all his interests in TMC to Charles Rantlett Flint for $1.2 million plus a 10-year consulting contract at $20,000 per year ($200,000 in present value). Flint combined TMC with four other firms to create CTR, which later became IBM. These two business offspring from Hollerith—German Hollerith Machine Corporation and International Business Machines Corporation—would in the future fight a battle to the death for control of business opportunities related to tabulators and the Hollerith legacy. And that battleground would encompass virtually all of Europe after World War I and, later, in World War II. Mr. Thomas J. Watson headed IBM during its CTR days, beginning in 1913. CTR held a tenuous share of the German market at the time. During World War I, the German government seized CTR's assets, they being property of an enemy national. Even so, after the war Watson was complimentary about how well CTR's assets were managed by an assigned German commissar during receivership, through which CTR gained greater visibility with German industrial and government concerns. Such contact benefited CTR as it later evolved into IBM.

After World War I—which ended at the 11^{th} hour, on the 11^{th} day, of the 11^{th} month in 1918—and the subsequent economically punitive treaty of Versailles, Germany's monetary debacle negatively affected Dehomag's business By 1922, Dehomag had incurred considerable debt which reached 450 billion inflated marks, or $104,000. The firm could not pay royalty fees owed CTR. To avoid default, Watson asked for 51 percent stock ownership, or he would simply let Dehomag and Heidinger go bankrupt. When Heidinger agreed to 51 percent, Watson upped the ante to 90%. Heidinger was left with about 10 percent equity which would be useful to conceal CTR/IBM's foreign ownership of Dehomag if another war broke out. And that 10% could only be sold back to CTR. Simultaneously a threat was eliminated that had potential to dominate Germany, all of Europe, and challenge CTR's international ambitions and metamorphosis into IBM.

Dehomag became a tightly managed subsidiary after CTR changed its name to IBM in 1924. Nine years later, in 1933, a new German government began a systematic application of Dehomag equipment with a foreboding census count to determine the demographic “health” of the country. Voluntary and willing participation was expected by Germany's 60 million citizens, again about the population of the Roman Empire during its 1^{st} century census. The objective was to trace everyone's ancestry back to 1800, when Germany relaxed its citizenship laws, starting with counting the 41 million citizens in Prussia, Germany's largest state. For 1.35 million Reich Marks, Dehomag agreed to tabulate statistics on those 41 million people in just 120 days, beginning d4/Apr. 12, 1933—an objective met with assistance and training from IBM in New York. This led to greater investments in Germany by IBM, but not so much as to dislodge U.S. control of equipment and punch-card production for that nation and Europe. Even during the U.S. Depression, IBM invested some $1 million to expand Dehomag's market reach across all of Europe.

Voluntary participation in the 1933 German census helped generate new ciphers specific to begin tracing ancestry and heritage for every German citizen. In less than a decade, Dehomag went on to develop “solutions” that included digitizing German citizens with cipher-tattoos for punch-card processing with Dehomag machines. This included producing “public notification lists” to scheduling “relocation trains,” with dazzling accuracy and precision. The German government used its Dehomag-produced demographics to assert, by dicta, that specific citizens and any offspring thereof as predestined to servitude or death. And, by law, the dicta reached to any embryo conceived thereof. After generations of assimilation, distinctive biogenetic characteristics couldn't easily support fictitious-identity dicta in Germany the way FID:1 states used the slc24a5-cihper in the U.S. However, Dehomag tabulator equipment could encode and sort census documentation and other public data sources, including institutional registries from all manner or organizations, to create demographic-ciphers back to 1800, ciphers useful for “social reengineering” by government decree.

These demographic-cipher production and social reengineering practices would ultimately contribute to the total collapse of the German nation, the loss of some of its most brilliant citizens, including Dr. Albert Einstein, and Germany's inclusion in the history of mankind with other nations that used demographic-cipher production to commit atrocities in completely self-destructive ways. Dehomag, in the process, became a European profit center as orders for equipment followed German conquests, nation by nation, each then demographically “processed,” including fanatical efforts to identify every descendant from the 603,550-man census some 31 centuries prior. After World War II, Dehomag, its punch-card files, ciphers, records and methods thereof were absorbed by IBM, including methods for digitizing people with tattoos, or by other means, for processing with its equipment.

The Dehomag 1933 census contract to count 41 million people in Prussia demonstrated the versatility and speed of IBM technology. It also raised the bar for other nations, competing with Germany, to become better organized by applying similar technology. In the U.S. IBM successfully supported the voluntary adoption of a nine-digit national cipher through the Social Security Act. Two years after the 1933 German census contract, IBM won the contract to provide a nine-digit solution to implement Social Security. In doing so, enormous revenues from cipher-processing-equipment sales became possible as the U.S. population expanded, using ciphers specifically designed to be processed through IBM equipment. And, what started as a voluntary national cipher adopted by only one sixth of the U.S. population, would become compulsory over time for every embryo conceived. The acre of IBM punch-card files in Washington, D.C. as of 1939, would evolve, grow and later be converted and stored on new electromagnetic media, including disk drives and magnetic tapes. By the 1950s, the 80-column punch-card images were converted and stored on new electromagnetic storage media, including disk drives and magnetic tape. They were formatted with 80-charater records, and processed by IBM computers and other automation that replaced tabulators. The 80-column displays on many person computers, today, are silent witness to the same 80-columns on punch-cards used in the U.S., Germany and throughout the world.

Social Security's 1935 nine-digit cipher later breached its legislated purpose and became a commercial and public fictitious-identity cipher. Though the 1934 law precluded the Social Security Administration giving out the cipher for non-Social Security Administration purposes, no law prevented firms using IBM equipment from requesting private citizens voluntarily provide it, or make one up, to simplify managing accounting information. This loop-hole, in turn, created conditions for a de facto national cipher. As any one learned upon being sold IBM or similar equipment designed to process a nine-digit cipher, if the cipher were voluntarily provided there was no liability.

Like magic, the ciphers were provided, which IBM or similar equipment could readily process in the private sector, just as the same equipment was doing at the Social Security Administration. This allowed demand for IBM or similar equipment to incrementally expand through state and local governments, as well as private institutions, with a “side-door” use of the cipher legislated only for Social Security Administration purposes in 1935. In only three decades, the 1935 nine-digit cipher became a de facto national ID cipher that helped remove technical obstacles for creating interstate and national banking Institutions, centralized credit reporting agencies, national credit cards, and later conditions for fictitious-identity transgressions. These, too, were part of what IBM support made possible through passage and winning the 1935 Social Security contract, establishing a voluntary nine-digit cipher specific to the Social Security Administration.

During the 1960s and afterward, these ciphers helped fuel demand for credit card and other applications, along with centralized financial, credit and medical reporting systems. The cipher helped preclude one individual establishing multiple accounts or commercial identities in different regions of the country or a state. All of these applications were outside the originally legislated purpose of the 1935 nine-digit cipher, meaning if an individual voluntarily provided it, there could be little or no institutional liability, as with any nine-digit cipher someone might makeup or provide. The individual doing so became complicit in a conspiracy of questionable use, and had limited options if subsequent financial or other injury occurred. By abetting in creating or sharing the nine-digit cipher and any fictitious-identity defined thereof, the seed of fictitious-identity transgressions were sown by millions of unsuspecting individuals from 1935 to the 1960s.

The merger of telecommunications with computers, in the 1960s, and later through the Internet, set conditions for wide-scale fictitious-identity transgressions now reaching into billions of dollars annually. The ability to assert a fictitious-identity by dicta is again supported in the U.S. through the grid-lock of a legal precedent that creates little or no institutional liability for fictitious-identity transgressions. These, again, are matters left for each individual to resolve who may be affected by third-party dicta to claim another's resources and life-efforts by a mere assertion, even more casually than fictitious-identity dicta possible prior to 1865. Then, fictitious-identity dicta required common consent by a local community, informed by state law, anchored in Article IV of the Constitution. This contrasts to unresolved fictitious-identity transgressions of 2008, which become part of the national debt, either directly or indirectly. And therein may be impetus to nationalize a new fictitious-identity paradigm, perhaps even biogenetic-based, to address the short-comings of a 1935 nine-digit cipher “solution” designed by IBM. That IBM design left open modern computers' fictitious-identity transgressions through telecommunications and random access magnetic media instead of physically tabulated punch-cards. The merger of random-access computers and telecommunications creates conditions for the classic tradeoff Benjamin Franklin anticipated long ago: “They who would sacrifice liberty for security deserve neither liberty nor security.”

Though the 1935 nine-digit cipher dramatically increased revenues to tabulator/computer manufacturers in the 30s, 40s, 50s, 60s, 70s, 80s, 90s, and 2000s, its adverse effects on liberty, from poor implementation, is expanding a “balloon-payment” even if one doesn't count the some $50 billion annual impact on the national debt from fictitious-identity transgressions. That represents debt not formally approved by Congress or the president, and it is beyond the reach of the Supreme Court since the 1935 nine-digit cipher was legislated for one, and only one purpose: Social Security. The INVENTION herein may, for a period of time, help preclude biogenetic “solutions” while dramatically reducing further national debt accumulation from fictitious-identity transgressions.

The Commercial Use of Fictitious-Identity Ciphers Beyond Government

Public acceptance of a national cipher has been gradual and usually justified by arguments based on national security, crisis, progress, fairness, public welfare or some type of benefit distribution. The 1930's Depression greatly aided public acceptance of a national cipher as part of a government program. For example, the United States' nine-digit, national cipher is called the Social Security number. This cipher came into law beginning, in 1935, when the United States Congress passed legislation establishing a new retirement, disability, death and health insurance program called “Social Security.” Legislation thereof was signed into law by Franklin Delano Roosevelt, 32^{nd} president of the United States from 1933 to 1945. No previous president, in concert with the U.S. Congress, had directly or indirectly authorized what would in effect become a national cipher for every living soul who might request it. Nor had any prior leader or king in recorded world history ever assigned or attempted to assign a cipher to every living soul under a government's authority, on so vast a scale as attempted in the U.S.

To establish and issue a modern national cipher, on potentially so vast a scale, required technology that by the 1930s could support the projected massive bureaucratic needs of Social Security. Punch-card-tabulating machines, commercially available and mass-produced by that time, encompassed all the components necessary to sort, tabulate, copy, print, retrieve and electromechanically encode staggering amounts of data to administer Social Security and its new national cipher. IBM was the principal supplier of this equipment to the federal government, including its 400 series tabulators, its 80-series sorters, and its 10- and 20-series keypunches. As noted earlier, IBM dated back to 1911 as Computing, Tabulating and Recording, or CTR, the merger of four physically disparate and unrelated businesses. Computer Scale of America in Dayton, Ohio, was a trust that made scales displaying the price and weight of an item, used in butcher shops, as well as in certain industrial applications, like measuring out quantities of bolts. Tabulating Machines Company, based in Washington, D.C. which was not a trust, made early punch-card tabulators for government census counts; the machines were also used commercially by some businesses. And International Time Recording, located in Endicott, N.Y., which was also a trust, made clocks and other time-keeping equipment for factories tracking and recording employee hours, among other applications.

As previously noted, a U.S. citizen named Charles Ranlett Flint, known as the “king of trusts,” architected what became CTR. Near the end of the 19^{th} century and the beginning of the 20^{th} century, he also brought together various companies to form other monopolistic conglomerates, or trusts, in rubber, starch, bobbins, woolens and chewing gum. Flint was in fact architect of the International Time Recording trust and the Computing Scale of America trust. In modern parlance, he would also be deemed a “merchant of death,” a dealer in the lucrative trade of guns, aircraft and warships, often with both sides of the same conflict, whether in South America, Europe or wherever opportunity presented itself For example, Mr. Flint befriended Orville Wright and licensed the Wright aircraft technology to the German Kaiser (the Germanic spelling of Caesar, Czar being its Russian spelling) just in time for German aces to use Wright know-how against British and Americans pilots, soldiers, sailors and Marines during World War I. To him, the misapplication of census ciphers by a government, to the detriment of any demographic group, wasn't necessarily repulsive if profitable—if it could be done it should be done, he felt.

In 1911, when Mr. Flint formed the CTR trust, the stock was said to “hold a lot of water,” meaning its price was significantly inflated over the actual value of CTR's disparate firms. For three years, CTR remained an underperforming asset in need of dynamic leadership to fulfill Mr. Flint's vision of a national “information services trust.” Such an “information services trust” was well ahead of its time and not obviously in CTR's future from its three, unrelated, disjoint businesses. By 1914, the 64 year-old Flint found a man who could fulfill this vision. That man was 40, unemployed and recently married. His wife was expecting. The only company he ever tried to start went bankrupt. Also, in 1914, a federal court convicted and sentenced him to a year in jail. And his former employer had fired him. Still, Thomas J. Watson, Sr. was exactly the kind of man Mr. Flint sought, as Mr. Flint, himself, had his own brushes with federal law, especially antitrust law under which Mr. Watson was tried. So the conviction was not necessarily a deal-breaker for Flint, who assuaged the concerns of CTR's board, including its chairman, George F. Fairchild, about a potential “jailbird” running the company. Even so, CTR hired Watson on a probationary basis as general manager, pending appeal of his conviction. (reference: Robert Sobel's, IBM Colossus in Transition).

Charges for Watson's federal conviction came in 1913 while he worked for Mr. John Patterson at National Cash Register, or NCR. Watson was 23 when he started his NCR career in 1897. That year, he returned his cash register to NCR's local Buffalo, N.Y., branch when his almost-successful attempt at setting up a chain of butcher shops went bust (Watson's partner ran off with the business's cash). Only six years after joining NCR, Watson became the most successful NCR salesman in the nation. In one month alone, Watson sold some 1,200 cash registers. Patterson, the autocratic CEO of NCR, recognized Watson's considerable sales abilities and gave him an unusual assignment. Patterson had Watson pretend to resign from NCR after which Patterson supplied Watson $1 million to set up a dummy company to buy-out or put out of business NCR's competitors, especially those reselling used cash registers.

The Theodore Roosevelt Justice Department became aware of collusion between Patterson's NCR and Watson's “second-hand cash register exchange” business, home of the “knockers” which looked like competitors' machines (“knock-offs”) but were designed to malfunction and readily break-down. Knockers helped dramatically decrease demand for non-NCR registers, often forcing competitors to accept buy-out offers from Watson—or be put out of business. Discovery of the ruse led to antitrust charges against Patterson and his NCR management team, including Watson. These were among the first prosecutions under the Sherman Antitrust Act. After Patterson along with Watson and others were convicted, Watson refused to enter a plea bargain negotiated by Patterson and his NCR management team. So Patterson fired Watson, as he had many other very capable NCR managers over the years. Patterson gave Watson a $50,000 severance and a Pierce-Arrow car.

The conviction was subsequently dropped by Woodrow Wilson's newly staffed Justice Department. The favorable conditions to drop it were in part due to Patterson's and Watson's public civic-mindedness during a once-in-a-century flood through the Dayton area where NCR was headquartered. Patterson opened up the NCR cafeteria and its facilities to feed and shelter some 90,000 displaced people. He also converted NCR's production line to manufacturer quantities of row boats to aid relief efforts. He and NCR became state and national heroes, Watson briefly eclipsing even Patterson in the press's and public's gratitude. Watson received public credit for sending a train filled with water containers and other supplies from New York, which to Patterson appeared to be grandstanding. This, too, later contributed to Patterson firing Watson.

After the Justice Department dropped the conviction, ending Watson's probationary period at CTR, the board, with Flint's backing, gave Watson the presidency. Watson negotiated a $25,000 salary for himself (equivalent to $250,000 in present dollars), plus 5% of CTR's worldwide profits, and 1,220 shares of stock, then worth about $36,000. He would go on to stabilize and grow CTR vowing to make it larger than NCR. Watson anticipated increased commercial demand for CTR's products after World War I, especially Hollerith machines from its, Tabulating Machines subsidiary. Even when resources were scarce, Watson invested in a nascent TMC R&D effort. By 1921, a new device, called the lister-printer, helped fill out CTR's product line for applications beyond census tabulation, expanding use for automatic punch-card accounting in business and government agencies.

CTR had an international presence at its inception, including its census tabulating machines used in Austria, Canada, Norway, Russia and literally around the world. By 1924, Watson had complete control of CTR and renamed it International Business Machines, or IBM, each letter expanding on NCR—National/International, Cash/Business, Register/Machines. IBM would successfully internalize many NCR paradigms, especially selling techniques.

By the 1930s, Watson's compensation was $1000/day, or about $18 more per year than even Will Rogers at the time. As we will see, by then IBM's punch-card-tabulating machines were versatile enough to support a plan to introduce Social Security based on a modern national cipher never similarly applied before in the history of man. Watson would go on to win the major contracts for processing information in Roosevelt's New Deal, following the passage of the 1935 Social Security Act and the Wage Hour Act of 1937-1938, among other programs. The Du Pont family, in concert with other millionaires, denounced the New Deal as bolshevism, and Roosevelt as a traitor to his class, if not to the ideals of his country. Watson harbored no such notions according to Harry Hopkins, Roosevelt's closet aide.

Watson's machines were instrumental to the New Deal and Social Security. These machines would readily tabulate and record I work credits for determining benefit eligibility within the Social Security program. The categories of Social Security, then and now, are: (1) old-age, survivors, disability, and hospital insurance; (2) unemployment insurance; and (3) worker's compensation. The IBM tabulators and related equipment would go on to hold records of some 26 million Social Security registrants in 1939. By 1940 there were 30 million. The central punch-card file, as noted before, covered an acre of floor space.

The ravages of the Depression, after 1929, and the benevolent intent of Social Security to buffer society from similar future privations, helped assuage trepidation that any national cipher might otherwise engender. By and large, use of the Social Security cipher was limited to its legislated intent in its first few decades of operation. In fact, absent Social Security, as of 2007, the U.S. public debt might be significantly higher than its current aggregate, which is in excess of $37 trillion. To moderate public debt, funds were diverted from Social Security to other budgetary priorities and projects by Congress, after the 1950s. U.S. Treasury bonds were substituted for the diverted funds.

Such bonds are in good standing and can not be disparaged or questioned, in any way, under the U.S. Constitution:
The Congress shall have power to borrow money on the credit of the United States[.]
   Article I, Section 8 Clause 2
No money shall be drawn from the treasury, but in consequence of appropriations made by law[.]
   Article I, Section 9, Clause 7
The validity of the public debt of the United States, authorized by law . . . shall not be questioned [.]
   15^{th} Amendment, Section 4

The in excess of $37 trillion of U.S. public debt evidences the tremendous power and authority granted, under heaven, through the Constitution, to the U.S. Congress, exercised in conjunction with U.S. presidents Ronald Reagan, 1981 to 1989; George H. W. Bush, 1989 to 1993; William J. Clinton, 1993 to 2001; George W. Bush, 2001 to 2009; and precedents thereof and afterward. Under heaven, the U.S. Congress and U.S. presidents have been granted power through the Framers of the U.S. Constitution to expand U.S. public debt up to $1 quadrillion ($1,000,000,000,000,000 or $1×10¹⁵), or until such time the world economy objects, in no uncertain terms, to U.S. public debt approaching or exceeding that amount. The total value of all U.S. assets, as of 2007, represents about 5% of the potential $1 quadrillion free market ceiling on U.S. public debt, or about $50 trillion ($50,000,000,000,000 or $50×10¹²). Thus, the U.S. may resemble a bank (Italian for banco or bench, on which early financiers met clients) with currently secured assets of 5% on its potential $1 quadrillion of credit (Latin credo, meaning “I trust”).

Social Security is foundational to mitigating the in excess of $37 trillion in U.S. public debt and helping protect the some $50 trillion of all U.S. assets. Few things come close to the stabilizing effect Social Security has had on the U.S. economy and, indirectly, on the world economy. Social Security's moderating effect on free market forces, is in conjunction with the 1934 Securities Exchange act to regulate securities trading and to separate speculation in them from deposit banking by the public. They provided the principal safeguards to buffer the nation's economy from the pre- and early-1930s privation that led to startling bank closures, mortgage industry collapses, devastating swings in unemployment, liquidity crises, and vulnerability of millions of souls at the margins of life. In or about 1995, parts of these and relate acts established in or about 1934 were demurred by Congress and the president, opening the way to Structure Investment Vehicle (“SIV”) manipulation, “sub-prime” market speculation for home loans, and other forms of macroeconomic misconduct.

For example $1 trillion may be exposed to such structured speculation, providing profit, commissions and income to a host of private-parties. Eventually the $1 trillion may be written down, companies liquidated, and jobs lost. But the profits, commissions and incomes received by negligent private parties are unaffected. Subsequently, the lost $1 trillion may be replenished by the Federal Reserve to buttress flagging institutions and depleted liquidity. Therefore, the $1 trillion may casually become part of the national debt, without congressional appropriation, while releasing tremendous profits, commissions and incomes to private-parties. And that debt must be repaid at considerable interest, for decades, by the public, the $1 trillion acting as an entitlement through easy conversion to public debt.

Tremendously accurate modeling and forecasting systems are in place that can compute with extraordinary precision, for example, additional tax revenues if there is a 1% change in any tax rate. These systems may readily model the effect of a policy change, such as allowing one million “stated-income” loans and liquidity adversity after a “sub-prime” market collapse. Those modeling systems can compute the number of times SIV's may be iteratively resold, each cycle generating commissions, profits and incomes, before liquidity markets would become exhausted and collapse. Whether finite element of analytic models, the results are well-behaved under known economic constraints. And those computer models would predict, almost to the penny, the amount of capital infusion later needed form the Federal Reserve or other sources to “stabilize” the economy. These outcomes, therefore, may less be happenstance, while reflecting macroeconomic intentions and conduct. As with pre-1934 securities legislation, one might be well positioned to profit from SIV “churning,” short-selling, currency exchange rates, bond sales and the like with computer models run before and during certain policy changes, anticipating creation of new public debt.

In an attempt to buffer the public from such manipulations anticipated with banking and security acts in 1934, relaxed by the president and Congress in or about 1995, by law ciphers for the Social Security program could only be issued on a voluntary basis to the public, exclusively for the public's benefit, preventing private party diversion or manipulation of the accumulated Social Security trust funds. The ciphers weren't compulsory, originally, which aided passing legislation. The choice was left up to each individual whether or not to participate in Social Security and, therefore, to be issued a cipher. By law, the ciphers could not be used for other purposes, whether by private or public sector institutions or by any other party. Therefore, the public was left to believe these ciphers could never be construed or manipulated to establish any kind of national identification system or be commercialized. However, equipment processing the ciphers had no such sensibilities, nor the manufacturer or manufacturers of such equipment if equipment sales might increase from commercial use of the cipher after legislation were passed.

As with certain military and social reengineering uses of its equipment in Germany, IBM was not obligated to publicly disclose these possibilities for a nine-digit national cipher while designing and proposing its “business solution” to the U.S. government, prior to 1935. Nor was IBM required to do so by law under its privacy right through fictitious-identity as a corporate body. Nor was it required by law to publicly disclose, subsequently, that the German government contracted IBM to design a “solution” for systematically assigning fictitious-identities with six- to nine-digit ciphers, digitized as tattoos, for specific demographics, to readily process those digitized tattoos through IBM punch-card-tabulator equipment. The contract eventually included servicing equipment leased and installed, under contract, at “final destination” stations where train-loads of people arrived, each systematically assigned a fictitious-identity to “the benefit of the state”—and each train having a box or boxes of IBM punch-cards. Those IBM punch-cards contained ciphers, digitized as tattoos on living souls shuttled across Germany by a plethora of trains, each train and the parties therein all tracked by IBM punch-card-tabulation equipment to their “final destination.” [reference: Edwin Black's, IBM and the Holocaust]

After 1935, Social Security ciphers, in the U.S., were primarily used as legislated. The on-going evolution of punch-card-tabulating technology simplified managing this type of national cipher, one of the first ciphers in the world issued on a national basis since mankind began organizing into discrete nations some 5000 years ago. National enumerations have long been tools of nations and empires, usually for tax purposes or proportioning electoral representation, or for military conscription, or for socio-economic planning. Across history, such enumerations were sometimes voluntary and at other times compulsory, depending on a particular nation's practices.

However, census counts, in the past, were done in the absence of an assigned national cipher for each individual counted. This changed in the 20^{th} century as national ciphers, issued by governments, came to co-exist with national enumerations. Punch-car-tabulating technology and its later replacement, the electronic data processor or computer, proved a catalyst to automate demographic-cipher production and census counts. And concurrently with such enumerations, the same technology allowed national ciphers to be infused into populations, the Social Security cipher in the U.S. being one of the earliest to be done in the history of man on so massive a scale. Intrinsic to such a program were voluntary acceptance and assignment of a unique cipher to every eligible individual. If one didn't want to participate in Social Security, one need not apply for a cipher. These were the precursors enabling modern fictitious-identity transgressions under the auspices of legislation for distributing voluntarily social benefits.

Such benefits and services were, prior to the 1930s, regulated and legislated by local state governments without need for a national cipher to do so. However, as Herbert Hoover surmised, World War I's disruption of the world economy with the punitive effects of the treaty of Versailles led to the later collapse of the German economy. When its government could no longer service its debt, other European economies were adversely affected, as well. England ceased making payments in gold, to limit the outflow of that precious metal from its banks. The European liquidity crisis in turn destabilized the U.S. economy, the U.S. having made extensive loans to former belligerents in Europe, tying U.S. monetary stability to those economies. The roles of states in the U.S. were later affected.

Regarding European powers' entreaties to President Calvin Coolidge, Hoover's predecessor, to temporarily suspend debt payments, Coolidge noted they “hired the money” and were obligated to meet the terms of “hire,” which, of course, they couldn't. Allowing massive federal deficits, to shore-up markets during times of uncertainty, was practiced later in the 20^{th} century, not then. Europe's inevitable economic demise gave rise to dictatorships in Italy, Spain and Germany, among other nations, in parallel with a ruthless totalitarianism in the Soviet Union.

The European monetary crisis stressed institutional and public liquidity in the U.S., with market collapses, bank closures, mortgage failures, massive unemployment and demand for new U.S. leadership, even dictatorship, if necessary, to put things right. This would lead to legislation in the 1930s concentrating federal power previously diffused throughout the states, And that concentration was accelerated in conjunction with a national cipher, to replace localized and varying fictitious-identity methods used state-to-state to administer aid, promote employment, and exercise regulatory oversight on commercial enterprises. However, commercial enterprises operating across state boundaries, including banks, insurance companies, and other businesses, had similar cipher-needs to achieve their national aspirations. A national cipher acted as catalyst for these sweeping changes within and outside the U.S.

In the midst of these upheavals, IBM won two lucrative government contracts, among others, in the U.S. and in Germany. As a business, IBM did not see its role as telling government clients how to run their internal affairs, any more than an arms merchant might dictate how armaments might be used after a sale. If a government's intentions were honorable then IBM's solutions would amplify such intent. And even if a government's intentions were depraved, then so long as it met payment terms in its contract, IBM would provide equipment and services without favoritism. To do otherwise might secede markets to competitors if IBM quit such markets for ethical reasons, forgoing revenue and profits to the benefit of IBM's institutional and individual stockholders, as well as affecting growth. It might also cause IBM to become untrue to two men instrumental in forging IBM's core values through Mr. Thomas J. Watson, Sr. The first was Mr. John Patterson, president of NCR who molded Watson into a modern salesman to win at all cost through competitive analysis, with the “100% quota club” for a national sales force, with the “THINK” mantra, and closing sales by knowing clients' fears, uncertainties and suspicions. The other was Mr. Charles Flint, founder of CTR who hired Watson. Mr. Flint wouldn't hesitate to conduct trade around the world, even if it meant selling arms to belligerents on both sides of a conflict. He felt if something could be profitably done, it should be done. IBM prospered in a world of governments it didn't create, yet willingly traded, selling “solutions” that mirror the propensities and pathologies, alike, of nation-states it continues to serve.

### TECHNICAL BACKGROUND OF INVENTION

A network of over 4 million directly and loosely interconnected computer systems implement the international financial and credit reporting infrastructure. These systems support daily market activity affecting some $7 quadrillion ($7×10¹⁵) in debt serviced and updated through multiple terabits of information exchanged across international borders and among corporate, public and private institutions in over 130 nations. Credit and financial assets monitored by such systems include real estate, automobiles, boats, airplanes, capital acquisitions, consumer and ‘commercial purchases, consumer and commercial loans, government borrowing and diverse credit and debit card transactions. Over $1 quadrillion ($1×10¹⁵) in financial transactions are reconciled daily through computer platforms maintaining the international financial and credit infrastructure among governments, corporations, private sector institutions and individuals.

The aggregate database systems, containing over 7 quintillion bits of information (7×10¹⁸) sustaining these various transactions, run on a myriad of computers, made by a cacophony of diverse manufactures, all integrated with standardized communications, database protocols, and through a unique government issued cipher (“GOVERNMENT ISSUED CIPHER”) peculiar to each country. In the U.S., the GOVERNMENT ISSUED CIPHER is nine digits and uniquely identifies each beneficiary/contributor to the federal Social Security program and its derivatives, such as Medicare, Medicaid and so forth. Each citizen, resident, corporate, or charitable entity, in each country, is assigned a unique GOVERNMENT ISSUED CIPHER through his/her/its local or national government. That unique cipher facilitates access to the worldwide financial and credit reporting infrastructure, especially through local financial institutions and businesses. Such ciphers are used by corporations and private sector institutions to track employees, customers and vendors, as well as by governments to identify, tax and service citizens' and residents' needs. Academic institutions also depend on GOVERNMENT ISSUED CIPHERS to manage and administer student populations. Charitable institutions and religions, to one degree or another, rely on GOVERNMENT ISSUED CIPHERS as well. By law, these ciphers are now compulsory for tax reporting purposes.

So long as each GOVERNMENT ISSUED CIPHER is unique and one-to-one for each constituent within a nation, the architecture of the worldwide financial and credit reporting system provides tremendous convenience and economies for the consumer-based model that allows goods and services to flow freely intra-nationally and inter-nationally. GOVERNMENT ISSUED CIPHERS facilitate movement away from physical-currency-based economies of paper dollars and coins, while interconnecting evolving credit-based economies whereby financial transactions need not involve the exchange of physical-currency. This also simplifies credit reporting by institutions and individuals to private-party credit reporting agencies.

The benefits of a purely credit-based economy are readily apparent. Counterfeiting may be dramatically reduced along with costs to print and coin money. For example, in the U.S. the metal to mint a penny costs more than a penny's worth as a coin. However, a penny in a purely credit-based economy has no physical existence except as part of a bit-field on a storage device or as part of a bit-stream in a financial transaction. In each instance, the physical resource to represent a penny, whether in its static or transactional form, may be less than one sextillionth (10⁻²¹) the value of the penny itself. This would allow such an economy to have virtually unlimited “scalability.” Globally interconnected economies could potentially serve the transactional needs of every living soul on earth.

Additionally, currency exchange of dissimilar physical currencies between countries would be obviated. All currency translations would be fully automated and dynamic at the time of purchase or other transaction, further increasing world trade efficiencies. Free-market forces would have greater play in setting prices that might otherwise be more difficult when currencies help insulate markets from one another.

### Telematic and Non-Telematic Ciphers

Non-telematic ciphers (“NON-TELEMATIC CIPHERS”) require a physical presence or authenticated documentation and/or a verifiable signature by a person to access a database or other form of information repository. For thousands of years, governments, institutions and agencies have used NON-TELEMATIC CIPHERS in a host of applications, especially in banking, finance and accounting. A bank draft account is a long-standing application of NON-TELEMATIC CIPHERS. By design, telematic ciphers (“TELEMATIC CIPHERS”) provide access to databases or other information repositories through telephone, Internet, or other telecommunication technologies that reduce or negate access barriers normally imposed through physical or in-person contact, authenticated documentation, signature verification, or other forms of physical authentication always required with NON-TELEMATIC CIPHERS. The original Social Security system was designed assuming NON-TELEMATIC CIPHERS processed with physical punch-cards, tabulators and sorters. The ciphers were not originally designed for TELEMATIC applications involving remote verification, varied commercial uses, or purposes other than a static punch-card based data file requiring physical access and physical authentication specific to the Social Security program.

### PREFERRED EMBODIMENT OF INVENTION OR EXAMPLE THEREOF

The worldwide financial and credit database infrastructure is defined as a vector, W. W is limited to a population of one billion for purposes of this example:
W={F₁μF₂, F₃, F₄, F₅, F₆, F₇, F₈, F₉, F₁₀, . . . , F_{999,999,999}}
where: Fₙ=¹Rₙ, ²Rₙ, ³Rₙ, . . . , ^{m}Rₙ
ⁱRₙ=, ⁱP_{n,1}, ⁱP_{n,3}, . . . , ⁱP_{n,α}, ⁱV_{n,1}, ⁱV_{n,2}, ⁱV_{n,3}, . . . , ⁱV_{n,β}
where: Fₙ is the fictitious-identity related data of the n^{th} individual
Cₙ is the fictitious-identity cipher assigned the n^{th} individual
ⁱRₙ is a record repository of the i^{th} financial, credit, private or public institution with information on the n^{th} individual
ⁱP_{n,j} is the j^{th} personal or identifying piece of information about the n^{th} individual in an institutional
   record repository ⁱRₙ
ⁱV_{n,k} is the k^{th} quantitative value, such as a bank balance, invoice amount, stock value, insurance
   premium and so forth of the n^{th} individual in an institutional record repository ⁱRₙ

For the purposes of this INVENTION, all Fₙ are presumed fictitious after they are extant. In the U.S., an Fₙ is usually begun with a “breeder document” such as a state-issued birth certificate or a federally-issued naturalization document related to an actual person Aₙ. In both instances, a government official initiates a new fictitious-identity, supported by appropriate private-party witnesses and name declaration, by dicta, if a new birth; or foreign documents, name-declaration-dicta and witnesses thereof if a naturalization. The government then assigns a Cₙ by dicta allowing the person to create an Fₙ, no matter how complex that Fₙ might become later. After establishing an Fₙ, access to resources in any of its ⁱRₙ's is through knowing Cₙ, though it may not be legal to use the cipher outside of a specifically legislated purpose. So it may or may not be legal to use such a cipher to establish a fictitious-identity through a host of institutions, ¹Rₙ, ²Rₙ, ³Rₙ, . . . , ^{m}Rₙ. Still, a party may access the resources of each ⁱRₙ using personal or descriptive information within one or more ⁱP_{n,j}'s, within any ⁱRₙ, through a fictitious-identity assertion.

So long as a fictitious-identity assertion includes the correct fictitious-identity cipher, C, (optionally), or portion of it, along with requested ⁱP_{n,j}, then Fₙ, is considered legally accessed through ⁱRₙ and the assertion is not construed a fictitious-identity transgression. The reality of the assertion is unknown: it may or may not be a fictitious-identity transgression. And if it is a transgression, the transgressor, T_{q}, is indistinguishable from the actual person Aₙ legally associated with Cₙ, Fₙ, and any respective ⁱRₙ by which a fictitious-identity assertion is made to use, secure or access resources associated with Fₙ.

Every tₓ transgression by T_{q} may not be immediately detected. If detected after a particular tₓ then the loss is either absorbed by a credit-approving institution or by an Aₙ if the tₓ is not reported in a timely manner.

Currently all T_{q}'s and their tₓ's represent some $50 billion in annual losses to affected Aₙ's and institutions serving them. Over 10 million Aₙ's are affected annually. At present there is little a government, institution, or agency can do to identity T_{q}'s until after a transgression. And T_{q}'s generally do not transgress a particular Fₙ, long enough to be traced. After an Fₙ is transgressed with any of its ⁱRₙ's, the transgressor may quickly move on to new Fₙ's.

Let ^{T}Fₙ exist purely for the purpose of detecting transgressions. ^{T}Fₙ is not associated with any real person, but exists purely for monitoring transgressions, since ^{T}Fₙ's with their related ^{T}Cₙ TRANSGRESSION-CIPHERS exist for the sole purpose of identifying T_{q}'s at the moment of transgression. This differs from detection after-the-fact when an Aₙ legally associated with an Fₙ reports a transgression, which in and of itself may or may not be a transgression. Unlike transactions with Fₙ's, there is no legal ambiguity whatsoever that a ^{T}Fₙ transaction is anything other than a transgression, whether inadvertent or intentional—every single time, without ambiguity.

Suppose a particular public or private sector institution S has a database D of client accounts such that D={U₂, U₂, . . . , U_{Z}} where each Uₙ is associated with a particular Cₙ in Fₙ. Then D is in fact an instance of ⁱRₙ of Fₙ in W. INVENTION establishes the creation of biometrically-inert transgression-ciphers (“BIT-ciphers” or “TRANSGRESSION-CIPHERS”) ^{T}Cₙ's issued by a monitoring agency in coordination with the primary government agency that assigns Cₙ's to the general population. S uses its allocated ^{T}Cₙ's to create ^{T}Uₙ's which are not associated with any actual person Aₙ. Thus ^{T}D could have the form {U₁, ^{T}U₁, U₂, ^{T}U₂, U₃, ^{T}U₃, U₄, ^{T}U₄, U₅, ^{T}U₅, U₆, ^{T}U₆, U₇, ^{T}U₇, U₈, ^{T}U₈, U₉, ^{T}U₉, U₁₀, ^{T}U₁₀, U₁₁, ^{T}U₁₁, . . . , U_{z}, ^{T}U_{z}} where each ^{T}Uᵢ is embedded within ^{T}D as every other acrostic key, for example. The acrostic key can in fact be chosen based on design criteria to detect transgressions at S. In fact there may be multiple ^{T}U's per U, or vise versa, whether this be 2 to 1, 7 to 1, 10 to 1 and so forth, due to the decreasing price of storage. The acrostic key may also be randomly variable while acrostically encrypting, within set parameters. Those storage economies may be used to conceal ^{T}U's in specific multiples of seven or other number, or at random intervals within specific parameters. Furthermore, the ^{T}U's may have distinctive markers within or may be so encoded. This could optionally include specific non-existent zip-codes or phone numbers, or other indicators, if needed, to differentiate U's and ^{T}U's for processing, backup or other purposes, or as visible deterrents that the records are BEST2000C™ encrypted.

An alternative implementation is for S not to exist at all, except as ^{T}S composed exclusively of ^{T}Uᵢ's. For example ^{T}S's could be implemented by the U.S. Treasury or Secret Service or Federal Reserve or U.S. Marshall, in the U.S., or similar agencies in other governments, or even by an authorized non-governmental agency. ^{T}S's would be completely non-existent entities, while allowing access to its databases and ^{T}Cₙ's. Obviously, access to any ^{T}S information would be a fictitious-identity transgression and a potential violation of federal law subject to investigation by the FBI, U.S. Postal Inspector, or similar agency within the U.S. or other governments.

In any particular S database (including ^{T}S for discussion sake), the ^{T}Cₙ's do not have to be unique to encode the ^{T}Uᵢ's acrostically. In other words ^{T}Cₙ's can be one to many. Redundancy is not a problem since the S or ^{T}S database is acrostically encoded, no matter how many or few ^{T}Uᵢ's there are.

The ^{T}Uᵢ's would/may be divided into classes. ^{T}Uᵢ's with low acrostic frequency could be “high value,” such that when credit scores are run on their ^{T}Cₙ's they might be transgressed immediately. Other classifications would be of varying degrees and value to create a spectrum of interests when transgressors sample an S or ^{T}S database. There would also be singular or one of a kind ^{T}Uᵢ's of very high value. This would defeat searches for redundancies by transgressors. Some ^{T}Uᵢ's and ^{T}Cₙ's might be made very rare and distinctive. Others would be made obvious through excessive redundancies. A transgressor sampling such an S or ^{T}S database or archival storage would be remiss in using any ^{T}Uᵢ's in such a database or archival storage when redundant ^{T}Cₙ's are detected in different ^{T}Uᵢ's.

The detection of all or any ^{T}Uᵢ's and ^{T}Cₙ's may be at multiple levels. The first level would be at various companies or credit providing agencies (“CREDIT PROVIDERS”) that acrostically encode their databases with ^{T}Uᵢ's. They may be first responders to any transgression of their own databases acrostically encoded. Options include notifying the enterprise originating the transaction (“TRANSACTION ORIGINATOR”), while T_{q} is there in person, to photograph the suspected transgressor, or to direct security to question or detain the person, or otherwise delay the suspected transgressor from leaving the premises. If the transgression is processed by phone, either the phone number is captured or address information if the transaction involves any type of physical delivery. Such may be forwarded to investigating agencies, including the U.S. Postal Inspector, as circumstances may warrant.

If a physical credit card is produced, it might be kept, along with an image or photograph of the transgressor at the time the fictitious-identity assertion is made. This may encompass all CREDIT PROVIDERS, whether, banks, credit card companies, retail establishments, or other commercial or non-commercial enterprises allowing credit-based transactions using account numbers, personal or other information to challenge remote fictitious-identity assertions (that is assertions made through a local TRANSACTION ORIGINATOR and verified remotely through a central distribution database of one or more CREDIT PROVIDERS).

At the nexus of the INVENTION are the credit reporting agencies (“REPORTING AGENCIES”) and their systems/servers which process transactions remotely or in person. Invariably, these organizations approve billions of dollars in new credit card accounts, loans and other resources requested by individuals. FANTASTIC-7™ (“Fast-Access-Network of Transgression-Alert-Servers for Transparently-Implanted-Ciphers version 7”) is a server, program or other processor architecture that detects Biometrically-Inert Transgression-Ciphers (“BIT-Ciphers” or “TRANSGRESSION-CIPHERS”) described earlier as ^{T}Cₙ's. They are government issued ciphers, such as the Social Security number in the United States. However, BIT Ciphers are not attached to any real person and are used exclusively for detecting fictitious-identity transgressions.

Non-governmental or governmental agencies (“MONITORING AGENCIES”), such as the U.S. Treasury, FBI, U.S. Marshall, U.S. Postal Inspector, Secret Service, FTC or other similar agencies, or newly established agencies in the U.S. or elsewhere, may issue BIT-Ciphers allocated specifically for fictitious-identity transgression detection as allowed by the responsible governmental or non-governmental agency that controls all fictitious-identity ciphers, such as the Social Security Administration in the U.S. This may be done through appropriate legislation or other provisions of the law to deter fraudulent use of government-issued ciphers, such as the Social Security number.

A MONITORING AGENCY, like the U.S. Treasury or Federal Reserve System or specially created agency in the U.S., for example, may assign specific blocks of BIT-Ciphers to private and public institutions for purposes of creating and maintaining ^{T}S's with ^{T}Cₙ BIT-Ciphers—once receiving these from the issuing agency or MONITORING AGENCY. Acrostic encryption is used to embed the BIT-Ciphers within databases or archival storage with an acrostic key determining the frequency they are embedded based on indicators and multiples, such as prime numbers or other composite numbers. Additionally, indicators or special flags may be optionally embedded in ⁱRₙ's and their various fields to indicate use for fictitious-identity transgression detection.

The FANTASTIC-7™ network may encompass servers and or other processors that monitor credit reporting agencies' (“REPORTING AGENCIES”) transactions, such as Experian, TransUnion, and Equifax, or others. FANTASTIC-7™ servers or processors or software respond to REPORTING AGENCIES' detection of BIT-Cipher transgressions to establish new accounts or access information under existing fictitious-identities; to create new fictitious identities; or respond to a private-party fictitious-identity assertion to access resources or any information associated with a BIT-Cipher.

FANTASTIC-7™ may provide MONITORING AGENCIES or other institutions a range of action options, since the transgressor may be unaware of detection at the moment a fictitious-identity transgression occurs with a BIT-cipher. These include, but are not limited to:
A 1: A log that the fictitious-identity transgression, including all address, phone (trace, caller-ID, cell phone) or other information of transgressor, institution triggering detection, goods or services requested, time and date, expected delivery or pickup, and other useful data or metrics.
A2: A1 and notification to TRANSACTION ORGINIATOR (see below)—by phone, e-mail, on-line message or other means—to verbally notify transgressor that information provided is a fictitious-identity transgression subject to federal prosecution. Transgressor is notified that all information is being logged and archived by a federally authorized MONITORING AGENCY.
A3: Either overtly or covertly photograph or image the transgressor and forward with A1 metrics to MONITORING AGENCY through FANTASTIC-7™ or other transmission or delivery means.
A4: A3 and send an on-line message from MONITORING AGENCY or its server/processor to TRANSACTION ORIGINATOR—whether a retail store, bank, financial institution or any public or private institution providing financial, credit, retail, banking, or other transactional or information service—that the party making the fictions-identity assertion is a high-value or other-value transgressor to be detained by private-security personnel or law enforcement, as circumstances may warrant, without jeopardizing members of the public or any party. at TRANSACTION ORIGINATOR.
A5: A1 and perform surveillance of any address provided for shipment of any goods or services ordered through a fictitious-identity transgression with a BIT-Cipher. Based on probable cause, if any, parties at said address may be questioned by the U.S. Postal Inspector, based on delivery or knowledge of delivered goods or services, especially if a fictitious-identity transgression is by phone, Internet or other means.
A6: A1 and send a letter to the address that a fictitious-identity transgression occurred, and that the address may be subject to further investigation.
A7: A1 and A3 along with forwarding an image and letter to address captured regarding a possible fictitious-identity transgression associated with the address. Again, FANTASTIC-7™ and MONITORING AGENCIES primary objective is deterrence However, where information captured through FANTASTIC-7™ is probative, especially regarding A3 images and eyewitness corroboration, as well as multiple event captures of the same transgressor by different TRANSACTION ORIGINATORS, then appropriate action by MONITORING AGENCIES may be warranted.

Finally MONITORING AGENCY may create Web sites or embed existing Web sites with BIT-Ciphers, fictitious-identity profiles (^{T}U's) and other such fabricated data MONITORING AGENCY may authorize. Countermeasure lists may include transgression-ciphers or related information embedded on Web sites or, as a processing program's index-file labeled as “safe” when they are in fact transgression-ciphers. Other lists may be fictitious-identity ciphers construed as “avoid” or “dangerous” when in fact they are anything but. Embedding in this way within processing program's code or open Web sites, including through “appropriate” file names, is an additional countermeasure to “hacking” into such systems. As needed, some fabricated fictitious-identities may be fully operational, with credit resources, positive account balances, and so forth for long-term surveillance of high-value transgressors, whether foreign or domestic. Web sites frequented by transgressors may be embedded with ready-access, structured groups of BTT-Ciphers or fictitious-identity profiles (“Fictitious Identity Nationwide Detection Evidence Resource” or “FINDER”) and other such fabricated data by MONITORING AGENCY or other approved agency, through every public means available, including artificial credit cards and wallets left in major cities, in public places, including airplanes or other public transportation, or public and private facilities. “Dumpster diving” FINDER materials may be embedded in dumpsters in a plethora of locations. In addition, transgressors who acquire FINDER materials may pass them on to other transgressors, increasing MONITORING AGENCIES or other approved agencies' reach through FANTASTIC-7™ as FINDER is exchanged with new transgressors.

The limited modeling and simulated testing of FANTASTIC-7™ and FINDER, whether with the FBI, Secret Service, FTC, U.S. Treasury, ATF, State Department, and other agencies, reveal that transgressors become very cooperative with MONITORING AGENCIES and are effective eyewitnesses to corroborate FANTASTIC-7™ or collateral MONITORING AGENCIES' information regarding other transgressors. Furthermore, the media (including movie studios) have their roles to play in disclosing to public examples of FANTASTIC-7™ in operation, developing events and scenarios at TRANSACTION ORIGINATORS, MONITORING AGENCIES and REPORTING AGENCIES.

Finally, celebrities and high-visibility public figures, or everyone else, must deal with a host of challenges related to fictitious-identity transgression. According to Frank W. Abagnale, a federal expert on recidivist conduct:
A thirty-five-year-old New York busboy had the hubris to choose names off the Forbes 400 list, including Ross Perot, Oprah Winfrey, Michael Bloomberg, and Ted Turner, gleaned additional information on them from the Internet, and became them. Robert De Niro's identity was assumed by his movie double. Tiger Woods was victimized by a California man who rented a moving truck and a storage locker in his name. In chandler, Ariz., the identity of the retired police chief was taken over by a woman who loaded up at Wal-Mart and Sam's Club stores. Twin brothers were kicked off the popular American Idol show after police said they had bought a car using the stolen identities of two unwitting fans.
ChoicePoint, a big data warehouse, erringly released personal information to identity thieves who were posing as legitimate debt collectors and insurance agents. They wasted no time in stealing 162,000 individual files and used at least 750 people to commit fraud.
LexisNexis, the collector and seller of consumer information, admitted that more than 300,000 of its files had been swiped.
Time Warner, the giant media company, “lost” a container the size of a picnic cooler that contained forty computer backup tapes bearing the names and Social Security numbers of 600,000 current and former workers and outside contractors, along with details on dependents and beneficiaries. A storage company that Time Warner had hired said the container went missing while being transported. Time Warner said it could not rule out foul play. Indeed.
Bank of America said that it had “misplaced' backup tapes containing the records of 1.2 million federal employees, including U.S. senators and congress people, while they were being transferred to a backup data center. The information came from a federal government program that used Visa cards for government travel and procurement.
The San Jose Medical Group said that the financial and medical records of almost 185,000 current and former patients were put at risk when the building was broken into and two computers housing the information were stolen. Not long before the theft, the group had begun encrypting the information because of identity theft. Alas, it hadn't finished the job.
A hacker who broke into the system of DSW Shoe Warehouse got hold of the records of credit card transactions at 108 shoe stores for some 1.4 million customers. Among the victims was the head of the Federal Trade Commission, the main agency charged with battling identity theft.
At the University of California at Berkeley, someone swiped a laptop computer from the graduate school admissions office. It contained the personal information of 98,000 graduate students and applicants. Less than six months earlier, an attacker had broken into Berkeley computers and scooped up records on 600,000 students, faculty, and alumni.
A computer with files harboring the names and Social Security numbers of 70,000 current and former workers at Ford Motor Company was stolen.
Marriott International, the hotel chain, said that backup computer tapes in the Florida office of its time-share unit were missing. They contained the personal information of more than 200,000 people.
CardSystems Solutions, a big credit card payment processor, said that computer hackers may have compromised the personal data of more than 40 million cardholders . . . most of them MasterCard and Visa customers.
. . . [A} mid-level analyst at the Veterans Affairs agency foolishly took home a laptop computer and external hard drive to work on a project, something he had been doing regularly for years. He lived in a Maryland neighborhood that had been plagued by a string of burglaries. Sure enough, a robber broke into his house and swiped the computer. It happened to contain the names and Social Security numbers of a whopping 17.5 million veterans, everyone who had served and been discharged since the mid-1970s. Nervous veterans, their identities suddenly thrust into play, howled their outrage at the government's lax safeguard, and I don't blame them. Nearly two months later, the FBI recovered the laptop and said it didn't think the files had been accessed, but who knows.
   From Stealing Your Life, by Frank W. Abagnale.

These scenarios are addressed as follows by INVENTION, among other implementations possible. A celebrity or other high-profile individual, or anyone else, may have a fictitious-identity Fₙ and associated fictitious-identity cipher reengineered and redefined, while leaving the original to be publicly accessed as a BIT-Cipher for detecting fictitious-identity transgression. This can only be done with the assistance and permission of the celebrity or high-profile individual, or anyone else. However, with such permission, these BIT-Ciphers and related records may be among the most effective additions to FINDER for detecting high-value fictitious-identity transgressors.

In the case where millions of records are stolen from a company, INVENTION allows acrostically encoding BIT-Ciphers and related fictitious-identity data at defined frequencies within databases, backup tapes and other media. Since BIT-Ciphers may be assigned to particular companies or organizations, MONITORING AGENCIES may be first responders, detecting when a specific company had a fictitious-identity transgression, and helping localize when and how the compromise may have occurred. Specific online media or backup media may be acrostically encoded when defined BIT-Ciphers or indicators, to identify with more precision the particular item that may have been compromised. Such encoding may include fabricated fictitious-identity profiles preferred by transgressors.

The very fact that this patent exists, in conjunction with present modeling or on-going FANTASTIC-7™ development through MONITORING AGENCIES, may decrease fictitious-identity transgression up to 90% by transgressors or potential transgressors who may only read this patent. Preventing a potential transgressor from becoming a transgressor may be the best of all outcomes, since it may preclude arrest and/or incarceration of parties who might otherwise act in their own enlightened self-interest while respecting the Commandment:
“You shall not covet your neighbor's house. You shall not cover your neighbor's wife, or his manservant or maidservant, his ox or donkey, or anything that belongs to your neighbor. Exodus 20:17

As a public record, this patent acts as legal disclosure to all transgressors or would-be transgressors, anticipating any defense regarding entrapment or other defense strategy to avoid prosecution. Though such defense strategy may have been asserted previously regarding FANTASTIC-7™ and its use through MONITORING AGENCIES, the publication of this patent may preclude that alternative. Furthermore, on-line access to this patent, in any way, creates a public record of such disclosure for every individual doing so.

Fictitious-identity transgression by private-party assertion exploits a national ID system established by government for purposes other than mere commercial convenience. When misused, that ID system reflects similar economic pathologies of a prior U.S. national ID system, established under Article IV of the Constitution to predestine embryos for indefinite or life-long servitude. Implicit power to expropriate another's resources through fictitious-identity entitlement and private-party dicta are again tearing at the bonding fabric of society, with all the risk such pathological conduct manifested in the past. And again the solution may involve re-embracing and renewing precepts, from Transcript, which inform the better angels of mankind's nature through goodwill for one another, rather than through ficttious-idenitty dicta for self-aggrandizement.

On or about d4/Mar. 19, 2008, after filing this patent, the inventor received a letter from IBM disclosing the following scenario for inventor's consideration. The bracketed clarifications are by inventor. The letter is signed by Barbara A. Brickmeier, VP of Human Resources. Part is excerpted here:
Recently, data tapes [in IBM custody] were lost while being transported by [an IBM contractor]. Those [IBM] tapes contained primarily archival IBM [confidential and unspecified] employment-relayed information, including Social Security number [of current or former IBM employees and/or other recorded data]. After [IBM's] thorough investigation of the incident [including nine-digit ciphers on the tape], [IBM] concluded that the tape[s] [, lost by IBM's contractor,] were not associated with theft or any other unlawful activity[, though investigation is on-going]. [IBM has] no indication that [your confidential] personal information on the missing [IBM] tapes, which are not the type that can be read by personal computer [without widely available IBM conversion utilities], has been accessed or has been used for any improper purpose.
   Barbara A. Brickmeier, Vice President, IBM Human Resources
      Received by inventor on or about d4/Mar. 19, 2008

IBM is a recognized leader in data security services, selling billions of dollars in equipment, software and utilities to countless customers around the world to prevent confidential data compromises. In the above interim remedy, IBM offers a voluntary option for an individual to provide her nine-digit cipher to a second IBM contractor who may or may not exercise the same care as the first IBM contractor. By accepting the voluntary option, the precedent of disclosing personal information, including an individual's assigned nine-digit cipher, is perpetuated, contrary to the original intent of the 1935 Social Security Act creating a national cipher. In doing so, voluntarily, each individual assumes part of the liability for disclosure, misuse, injury or loss.

The art in the present INVENTION helps deter use of compromised confidential data, as well as discouraging anyone seeking it out in the first place. Furthermore, by acrostically encrypting storage media, including archival storage tapes, detecting misuse may occur at the time of a fictitious-identity transgression This is juxtaposed to exclusively using former or affected IBM employees as “trip-switches” to detect fictitious-identity transgressions days, weeks, months or years later.
With BEST2000C™, for example, Barbara A. Brickmeier, might just easily have written:
IBM archival tapes were encrypted with BEST2000C™. The tapes were populated with Biometrically-Inert Transgression-Ciphers (“BIT-Ciphers”) along with other related transgression-cipher record data. BIT-Ciphers may be monitored by federally authorized agencies continually, allowing instant detection of any party or parties attempting to use acrostically encrypted records on IBM storage media. Such instant detection greatly aids law enforcement in conjunction with private security services at the moment of transgression, whether the transgressing party is at home using a telephone, is logged on to the Internet, is sitting in a financial institution submitting paperwork, or is completing a transaction with any one of several million agencies that accept credit cards by phone, mail, the internet, or in person, around the world.

Then again, if IBM had a BEST2000C™ license, IBM would have no obligation to disclose the benefits of BEST2000C™ it might choose to engage or has engaged, if any. Nor would it or any other company have to disclose when tapes or other storage media may have been misplaced or made accessible other than by accident. Nor, under a BEST2000C™ license, would IBM, its worldwide clients, or any other enterprise need disclose whether or not all or any storage and media thereof are BET2000C™ acrostically encrypted, or for how long they and appropriate agencies monitor a transgressor's actions before apprehension, whether instantly or delayed, to conceal pattern and practice. Nor would law enforcement—whether the FBI, U.S. Treasury, Secret Service, U.S. Marshall, U.S. Postal Inspector, ATF, FTC, or other federal, state or local agencies, or similar agencies in foreign governments—be required to disclose how many apprehensions were, or are, triggered by instant detections of fictitious-identity transgressions through FANTASTIC-7™, FINDER and BEST2000C™ acrostically-encrypted, publicly-accessible information data repositories of all kinds.

THERE IS ONE THING THAT IS CERTAIN: the consequences of BEST2000C™'s existence as described in this art are real and on-going, even while this is being read, as is the case with different art developed by this inventor and deployed on IBM and other computers, in multiple national jurisdictions, that has already resulted in successful litigation won at state, state appellate and federal levels.

### BRIEF DESCRIPTION OF DIAGRAMS

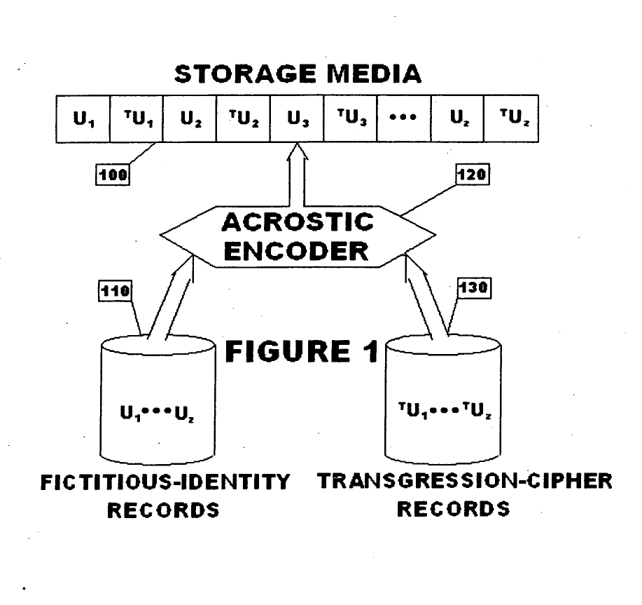

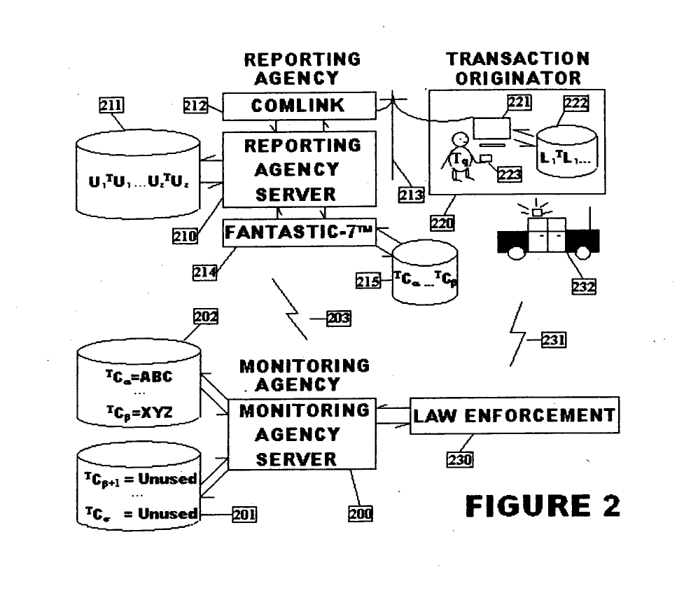

FIG. 1. is a process schematic of how STORAGE MEDIA 100 is acrostically encrypted using this art. Database or file or physical file 110 contains extant FICTITIOUS IDENTITIES used in the normal course of business by a government agency, company, academic institution or other business or agency. Database or file 130 contains FABRICATED FICTITIOUS IDENTITIES, labeled TRANSGRESSION-CIPHER RECORDS, using assigned TRANSGRESSION-CIPHERS described in FIG. 2. In this case, the acrostic key encrypts one TRANSGRESSION-CIPHER RECORD for each FICTITIOUS-IDENTITY RECORD, through this is only as example throughout the figures and description of the art. The ACROSTIC ENCODER uses the acrostic key to produce STORAGE MEDIA 100's organization and encoding. Redundancies are allowed, whether a particular ^{T}U_{J} is acrostically encrypted multiple times across the storage media, or if a particular ^{T}Cₙ is used to created multiple ^{T}U_{J}'s all on the same STORAGE MEDIA 100, which may be one or more random access or sequential digital storage devices, or one or more physical files of any kind.

FIG. 2. is a high-level view of the invention. MONITORING AGENCY may be authorized by the government as a private or public institution, separate or part of the U.S. Treasury, Secret Service, Federal Reserve, FBI, U.S. Postal Inspector, FTC, U.S. Marshall or any other LAW ENFORCEMENT or government approved private investigative agency, or similar entity in a foreign country. “Server” in any usage of this art may be construed as a general purpose server, full-sized computer, mid-sized computer, personal computer, or, alternately, may be a customized processor to perform a specific purpose. Additionally it may be a cluster of one or more servers so defined.

MONITORING AGENCY is allocated some number of TRANSGRESSION—CIPHERS, ^{T}Cₙ's, by the appropriate government agency which issues such ciphers to the general public. They are tracked by MONITORING AGENCY SERVER 200. For example, 10 million TRANSGRESSION-CIPHERS may be issued to MONITORING AGENCY, the actual number being more or less, and not publicly disclosed. These are represented as ^{T}C_{α} to ^{T}C_{σ} and are stored in databases or files 202 and 201. A portion of them are already allocated, or may become allocated to various companies, organizations and agencies, or be allocated by other means to fulfill MONITORING AGENCY's purpose. These are stored in database or file 202 with appropriate access and custody safeguards and provisions, the case with all databases in this art. Such is done within approved criteria assigned to MONITORING AGENCY through appropriate government oversight and laws thereof. For example, companies ABC and XYZ are assigned the first ^{T}C_{α} and the last ^{T}C_{β}, respectively. Multiple ^{T}Cₙ's may be assigned to any enterprise or agency, consistent with criteria established with MONITORING AGENCY trough appropriate government oversight and laws thereof.

^{T}C_{β+1} to ^{T}C_{σ} represent the remainder of all allocated ^{T}Cₙ's. They are contained in database or file 201. These TRANSGRESSION-CIPHERS are construed as “Unused.” They may be allocated by MONITORING AGENCY for special projects or as future circumstances may warrant through appropriate government oversight and laws thereof. 203 represents communications methods and infrastructure, whether terrestrial, satellite, Internet, or other means to monitor worldwide, financial and/or other transactions that may involve TRANSGRESSION-CIPHERS.

As an example of the art, 203 communications methods and infrastructure connect MONITORING AGENCY with REPORTING AGENCY, which may be a credit reporting agency like Experian, Trans Union, Equifax, or other such organizations in related fields or collateral ones where TRASGRESSION-CIPHERS might appear. 210 is the server for REPORTING AGENCY using database or file 211 for approving or denying requests presented to REPORTING AGENCY through 212 communications infrastructure, which may be the same or different from 203. This allows contact with a multitude of TRANSACTION ORIGINATORS, one of which is 220. 213 may be terrestrial, satellite, or other means for completing financial or other transactions between REPORTING AGENCY and TRANSACTION ORIGINATOR

REPORTING AGENCY'S 211 database or file contains, in this example, acrostically encrypted records described in INVENTION. Uᵢ's represent FICTITIOUS-IDENTITY RECORDS with established Cₙ's. ^{T}U_{C}'s represent TRANSGRESSION-CIPHER RECORDS fabricated with ^{T}Cₙ's. The 214 Fast-Access Network of Transgression Alert Servers for Transparently Implanted Ciphers version 7 (herein “FANTASTIC-7™) is a server or program on a server that registers any ^{T}Cₙ processed by REPORTING AGENCY SERVER 210. Such occurs when a credit check may be done to open a new account, or to verify the balance of a ^{T}U_{B}, or to access ^{T}Cₙ or ^{T}Uⱼ in any way whatsoever. The art defines various responses to such detection. FANTASTIC-7™ 213 references database or file 215 to detect TRANSGRESSION-CIPHERS that may be processed by REPORTING AGENCY SERVER 210.

The institution, business or agency submitting a request to 210 REPORTING AGENCY SERVER is the 220 TRANSACTION ORIGINATOR. Transactions are processed with 221 at TRANSACTION ORIGINATOR, which may be a simple terminal with little or no computing capability, or it may be a server. If 221 is a server, then it may have a local database or file 222, which may also be acrostically encrypted with the present art, using assigned ^{T}Cₙ's, allowing local detection of FICTITIOUS-IDENTITY TRANSGRESSIONS as well as detection by REPORTING AGENCY and/or MONITORING AGENCY. In using a TRANSGRESSION-CIPHER, transgressor 223, designated T_{q}, triggers a FICTITIOUS-IDENTITY TRANSGRESSION. 214 FANTASTIC-7™ notifies MONITORING AGENCY through its 200 SERVER. MONITORING AGENCY may establish direct contact with TRANSACTION ORIGINATOR through 203 communications to execute scenarios developed in art. This includes notifying LAW ENFORCEMENT or other investigative agency 230, such as the U.S. Treasury, FBI, U.S. Postal Inspector, FTC, U.S. Marshall and so forth.

As circumstances may warrant, 230 may dispatch LAW ENFORCEMENT personnel 232 or private security personnel, or notify personnel on-site at TRANSACTION ORIGINATOR 220, based on established response scenarios developed in this art. Or 230 may enable surveillance, including recording transgressor 223's vehicle license, or following transgressor 223 after 223 departs TRANSACTION ORIGINATOR 220, or tracking phone contact and mail shipments in conjunction with the FBI, Secret Service, U.S. Marshall, U.S. Postal Inspector or other such investigative agencies legally enabled to track TRANSGRESSION-CIPHERS by phone, mail, Internet, surveillance or other means. If circumstances warrant, 230 may also detain or request that transgressor 223 be detained for question, or apprehend 223 outright, consistent with appropriate government oversight and laws thereof. Other alternatives, described in the art, are available to 230 LAW ENFORCEMENT if 223 transgressor initiates a FICTITIOUS-IDENTITY TRANSGRESSION via phone or via the Internet, or while applying for a loan or opening an account at a branch location. TRANSGRESSION-CIPHERS allow detection at the time a FICTITIOUS-IDENTITY ASSERTION is made, rather than days, weeks, months or years later when reported by an injured party. Such after-the-fact reports, themselves, must be carefully scrutinized before taking any legal action, which is NOT the case with TRANSGRESSION-CIPHERS and their related FICTITIOUS-IDENTITY record data.

I claim without excluding derivative of collateral embodiments:

1) Let W be a database or subset thereof, existing on a single computer or cross-supported with multiple, interconnected computers that may or may not be geographically dispersed; where W is composed of, among other information, records for various parties such as individuals, businesses, institutions of all kind, or government agencies of any kind (“ENTITIES”); and said records contain financial, medical, asset, transactional or any other type of information for a party or parties (“PARTY” or “PARTIES”) represented on W; that each such record is referred to as a fictitious-identity record (“FID-record”) since at any given moment in time it is unknown if the record is exclusive to an originally authorized PARTY or an unauthorized person (“TRANSGRESSOR”); that each such FID record has one or more fictitious-identity ciphers (“FID-ciphers”) associated with it for identifying the PARTY who may legally access, update or otherwise affect the status or contents of said FID-record; wherein such a FID-cipher or FID-ciphers are issued—whether sequentially, randomly, or alphanumerically—by a private ENTITTY or legally issued by a government ENTITY for purpose of identifying and/or verifying PARTY who may access a particular piece of FID-record information, anywhere within W, in any way; then INVENTION is a method that comprises acrostically encrypting W to detect or deter unauthorized access to W by embedding encoded ciphers (“TRANSGRESSION-ciphers”), selectively issued as described in the art.

2) A method based on claim 1. comprising a subset of all possible permutations of a cipher used by an ENTITY for identification purposes by which such subset is set aside and designated solely for use as TRANSGRESSION-ciphers, appropriately concealed from general knowledge that such subset of ciphers are so designated as may be allowed and proscribed by applicable law, if any.

3) A method based on claim 1. comprising a controlling government ENTITY that assigns TRANSGRESSION-ciphers to other government ENTITIES or private ENTITIES for use within this INVENTION in any way, in conjunction with FID-ciphers for general use, including but not limited to social services, public benefit programs, tax functions, establishing credit and other transactional, financial, medical or data management applications.

4) The method of claim 1. comprising acrostically encrypting all or some or one sub-databases or sub-database within W, specific to a particular ENTITY'S records, inclusive of archival, off-line or backup or other storage media of any kind containing ENTITY'S records, with TRANSGRESSION-ciphers and fabricated transgression-records (“TRANSGRESSION-records”) representing non-existent PARTIES or ENTITIES, whether one to one or in some ratio of TRANSGRESSION-records to FID-records particular to ENTITY, called the Ratio of Acrostic Key Encryption (“RAKE”), whereby different RAKES may be used for different database record groupings of ENTITY. Alternately, one TRANSGRESSION-cipher may be singularly embedded or redundantly-embedded, such that a TRANSGRESSOR could not readily discern it (singularly) or immediately discern it (redundantly-embedded) whereby a multitude of TRANSGRESSION-records would be identical relative to the makeup of said database group or groupings within W.

5) The method of claim 1. comprising WEB sites or other publicly accessible venues embedded with TRANSGRESSION-ciphers and TRANSGRESSION-records, easily accessible to TRANSGRESSORS. Such sites would allow TRANSGRESSORS to misappropriate TRANSGRESSION-ciphers and disseminated them to other TRANSGkRESSORS, while being tracked by a designated agency, whether private or public, through fabricated TRANSGRESSION-records and related accounting information, synthesized for long-term surveillance of misappropriated and misused TRANSGRESSION-ciphers. Also, wholly fabricated WEB sites that are established for this reason may be produced by a designated agency, whether private or public within and proscribed by applicable law, if any.

6) A method of claim 1. comprising printed errata containing TRANSGRESSION-ciphers and records, casually discarded in waste receptacles or locations (“FACILITATION POINTS”) across a broad geographic region. This allows seeding up to tens of thousands of such FACILITATION POINTS, for already simulated scenarios, and more for actual seeding purposes, near businesses, restaurants, airports, and other venues that may be favored by TRANSGRESSORS. This includes, but is not limited to producing TRANSGRESSION-cards, which appear to be regular credit cards, seeded as noted, but are based on TRANSGRESSION-ciphers and TRANSGRESSION-records and fabricated accounts to detect, track, and surveille TRANSGRESSORS' pattern and practice of misconduct.

7) A method of claim 1. comprising reengineering high-profile or any other PARTY'S FID-cipher and related FID-records as a TRANSGRESSION-cipher with TRANSGRESSION-records, especially regarding FID-ciphers repeatedly compromised by TRANSGRESSORS, including those of celebrities, athletes and any PARTY with a public profile affected by recidivist TRANSGRESSOR misconduct. Such is facilitated with permission of affected PARTY prior to reengineering a new FID-cipher and FID-records by a controlling government agency within applicable law, if any.
